(19) United States
(12) Patent Application Publication
(10) Pub. No.: US 2006/0064485 A1
(43) Pub. Date: Mar. 23, 2006

(54) Methods for service monitoring and control

(75) Inventors: Anthony Baron, Woodinville, WA (US); Kathryn Pizzo, Bellevue, WA (US); Michael Sarabosing, Bellevue, WA (US); Edhi Sarwono, Redmond, WA (US); Frank Zakrajsek, Carnation, WA (US)

Correspondence Address: WOLF GREENFIELD (Microsoft Corporation);C/O WOLF, GREENFIELD & SACKS, P.C., FEDERAL RESERVE PLAZA, 600 ATLANTIC AVENUE, BOSTON, MA, 02210-2206, US

(73) Assignee: Microsoft Corporation, Redmond, WA (US)

(21) Appl. No.: 10/994,684

(22) Filed: Nov. 22, 2004

Related U.S. Application Data
(63) Continuation of application No. 10/943,762, filed on Sep. 17, 2004.

(51) Int. Cl. G06F 15/173

(52) U.S. Cl. 709/224

(57) ABSTRACT

In one aspect, a method of instructing operators in a best practices implementation of a service monitoring and control (SMC) facility performing a plurality of functions in a computer system comprising a plurality of services to be monitored is provided. The method comprises an act of providing best practices instructions for the implementation of the SMC facility in a hierarchical manner so that the implementation of the SMC facility is described as comprising a plurality of top level activities to be performed during the operation of the SMC, with each of the plurality of top level activities being described as comprising at least one lower level sub-activity, the top level activities comprising, assessing performance of the SMC facility, in response to information learned during assessing the performance of the SMC facility, implementing at least one change in the SMC facility, monitoring the computer system with the changed SMC facility for an occurrence of at least one event, and automatically performing at least one control action in response to the occurrence of the at least one event. In another aspect, a top-level activity of collaborating with one or more developers is described, resulting in a change to at least one change to software executed on the computer system. In another aspect, at least a part of the effectiveness of an SMC facility is automatically assessed, and in response, one of the plurality of functions performed by the SMC facility is automatically changed.

### RELATED APPLICATION

This application is a continuation (CON) and claims the benefit under 35 U.S.C. § 120 of U.S. application Ser. No. 10/943,762, entitled “METHODS FOR SERVICE MONITORING AND CONTROL,” filed on Sep. 17, 2004, which is herein incorporated by reference in its entirety.

### FIELD OF THE INVENTION

The present invention relates to operation of a service monitoring and control facility in a computer system comprising a plurality of services to be monitored.

### BACKGROUND OF THE INVENTION

Networked computer systems play important roles in the operation of many businesses and organizations. The performance of a computer system providing services to a business and/or customers of a business may be integral to the successful operation of the business. A computer system refers generally to any collection of one or more devices interconnected to perform a desired function, provide one or more services, and/or to carry out various operations of an organization, such as a business corporation, etc.

When a computer system supports one or more operations of a business or enterprise, such as providing the infrastructure for the business itself, providing services to the business and/or its customers, etc., the computer system is often referred to as an enterprise system. An enterprise system may be anywhere from two or more computers networked locally to tens, hundreds, thousands or any number of devices either connected locally or widely distributed over multiple locations. An enterprise system may operate in part over a local area network (LAN) and/or other networks that support various operations of an enterprise such as providing various services to its end users or clients.

In some enterprise systems, the operation and maintenance of the system is delegated to one or more administrators that make up the system's information technology (IT) organization. The IT organization may set-up a computer system to provide end users with various application or transactional services, access to data, network access, etc., and establish the environment, security and permissions landscape and other capabilities of the computer system. This model allows dedicated personnel to customize the system, centralize application installation, establish access permissions, and generally handle the operation of the enterprise in a way that is largely transparent to the end user. The day-to-day maintenance and servicing of the system as well as the contributing personnel are referred to as IT operations (or “operations” for short).

As computer systems become more complex and as businesses continue to rely more on the resources and services provided by their respective enterprise systems, maintaining the system and ensuring that services provided by the system are available becomes increasingly important, more complex and difficult to achieve. Many IT operations have addressed this problem by investing in system management software or enterprise management suites designed to provide operations with better visibility and monitoring control of their systems. However, these tools often fail to meet the expectations of an IT organization. For example, some tools may be difficult to integrate and/or may require significant engineering and development resources to customize to a specific system. In addition, such tools may not scale well to a growing and changing enterprise system. As a result, relatively expensive management tools are implemented employing only the simplest and most rudimentary monitoring functions.

In addition, operations often handle problems as they arise, leading to a patchwork of solutions that become difficult to understand and maintain. In general, different IT organizations approach similar operational challenges very differently, without any cohesive guidelines regarding how to set-up, configure and maintain an enterprise system.

### SUMMARY OF THE INVENTION

One aspect of the present invention includes a method of instructing operators in a best practices implementation of a service monitoring and control (SMC) facility in a computer system comprising a plurality of services to be monitored, the SMC facility performing a plurality of functions. The instructions for implementing the SMC facility describe the SMC facility in a hierarchical manner comprising a plurality of top level activities to be performed during the operation of the SMC, with each of the plurality of top level activities being described as comprising at least one lower level sub-activity. The top level activities comprise assessing performance of the SMC facility, in response to information learned during assessing the performance of the SMC facility, implementing at least one change in the SMC facility, monitoring the computer system with the changed SMC facility for an occurrence of at least one event, and automatically performing at least one control action in response to the occurrence of the at least one event.

Another aspect of the present invention includes a method of operating a service monitoring and control (SMC) facility in a computer system comprising a plurality of services to be monitored, the SMC facility performing a plurality of functions. The best practices instructions to be followed to implement the SMC facility are described in a hierarchical manner comprising a plurality of top level activities to be performed during the operation of the SMC, with each of the plurality of top level activities being described as comprising at least one lower level sub-action. The top level activities comprise assessing performance of the SMC facility, in response to information learned during assessing the performance of the SMC facility, implementing at least one change in the SMC facility, monitoring the computer system with the changed SMC facility for an occurrence of at least one event, and automatically performing at least one control action in response to the occurrence of the at least one event.

Another aspect of the present invention includes a method of instructing operators in a best practices operation of a service monitoring and control (SMC) facility in a computer system comprising a plurality of services to be monitored, the SMC facility performing a plurality of functions, the computer system being supported by at least one developer that develops software executed by the computer system to provide at least one of the plurality of services. The method comprises an act of instructing operators to, during operation of the SMC facility, assess an effectiveness of the SMC facility in monitoring the computer system, and in response to assessments made during operation, request that the at least one developer implement at least one change to the software executed by the computer system to facilitate improved performance of the SMC facility.

Another aspect of the present invention includes a method of operating a service monitoring and control (SMC) facility in a computer system comprising a plurality of services to be monitored, the SMC facility performing a plurality of functions, the computer system being supported by at least one developer that develops software executed by the computer system. The method comprises acts of, during operation of the SMC facility, assessing an effectiveness of the SMC facility in monitoring the computer system, and in response to assessments made during operation, requesting that the at least one developer implement at least one change to the software executed by the computer system to facilitate improved performance of the SMC facility.

Another aspect of the present invention includes a method of operating a service monitoring and control (SMC) facility in a computer system comprising a plurality of services to be monitored, the SMC facility performing a plurality of functions, the method comprising computer-implemented acts of during operation of the SMC facility, automatically assessing, at least in part, an effectiveness of the SMC facility in monitoring the computer system; and in response to the act of automatically assessing, automatically changing at least one of the plurality of functions performed by the SMC facility.

Another aspect of the present invention includes a computer readable medium encoded with a program for execution on at least one processor, the program, when executed on the at least one processor, performing a method of operating, at least in part, a service monitoring and control (SMC) facility in a computer system comprising a plurality of services to be monitored, the SMC facility performing a plurality of functions, the method comprising acts of during operation of the SMC facility, automatically assessing, at least in part, an effectiveness of the SMC facility in monitoring the computer system, and in response to the act of automatically assessing, automatically changing at least one of the plurality of functions performed by the SMC facility.

Another aspect of the present invention includes an apparatus adapted to operate, at least in part, a service monitoring and control (SMC) facility in a computer system comprising a plurality of services to be monitored, the SMC facility performing a plurality of functions, the apparatus comprising at least one input adapted to receive information about the computer system, and at least one controller adapted to, during operation of the SMC facility, automatically assess, at least in part, an effectiveness of the SMC facility in monitoring the computer system, and in response to automatically assessing, to automatically change at least one of the plurality of functions performed by the SMC facility.

Another aspect of the present invention includes a method of instructing users in a best practices operation of a service monitoring and control (SMC) facility in a computer system comprising a plurality of services to be monitored, the SMC facility performing a plurality of functions, the method comprising an act of instructing users to automatically assess, during operation of the SMC facility, the effectiveness of the SMC facility in monitoring the computer system, and to program the SMC facility to automatically change at least one of the plurality of functions performed by the SMC facility in response to assessments made during operation.

### BRIEF DESCRIPTION OF THE DRAWINGS

FIG. 1 illustrates a flow diagram of top-level activities for implementing and administering a service monitoring and control facility, in accordance with one embodiment of the present invention; and

FIG. 2 illustrates a flow diagram of top-level activities and lower level sub-activities for implementing and administering a service monitoring and control (SMC) facility, in accordance with one embodiment of the present invention.

FIG. 3 illustrates a diagram of the Microsoft Operations Framework (MOF) and associated service management functions (SMFs);

FIG. 4 illustrates a diagram of an organization's service component decomposition structure;

FIG. 5 illustrates a flow diagram of core processes for implementing an SMC facility, in accordance with one embodiment of the present invention;

FIG. 6 illustrates a diagram showing main activities within an establish process, in accordance with one embodiment of the present invention;

FIG. 7 is a diagram illustrating that the main activities and sub-activities of an establish process may be performed in sequence and/or in parallel, in accordance with one embodiment of the present invention;

FIG. 8 illustrates a diagram showing main activities within an assess process, in accordance with one embodiment of the present invention;

FIG. 9 illustrates a diagram showing main activities within an engage software development process, in accordance with one embodiment of the present invention;

FIG. 10 illustrates a diagram showing main activities within an implement process, in accordance with one embodiment of the present invention;

FIG. 11 illustrates a diagram showing a main activity within a monitor process, in accordance with one embodiment of the present invention;

FIG. 12 illustrates a diagram showing a main activity within a control process, in accordance with one embodiment of the present invention; and

FIG. 13 illustrates a diagram showing the interactions between the SMFs in the operating quadrant of the MOF process model.

### DETAILED DESCRIPTION

Applicants have recognized that difficulties in maintaining a computer system, such as an organization's enterprise system include not only the technical deficiencies of many system management tools, but extend to the relatively haphazard approach IT operations have taken in understanding their computer system and in solving maintenance, management and availability problems. Many service failures in an enterprise system may be attributable to so called non-technology sources, for example, failures due to operation's misconceptions about the system or misunderstanding about how the system is supposed to operate, rather than failures or anomalous behavior in the software and/or hardware comprising the computer system.

In one embodiment of the present invention, a generic end-to-end service monitoring and control (SMC) process is provided. The process includes guidance provided in a logical manner that allows IT administrators at varying levels of experience to understand and appreciate the activities involved in providing effective service monitoring and control. Service monitoring includes any of numerous tasks involved in examining the health, status and/or performance of a computer system. Components of a computer system that may be monitored include, but are not limited to, any one of or combinations of software applications, services, middleware, operating systems, hardware components, networking and access facilities, environmental parameters and variables, etc. The term control includes any automatically initiated response to an occurrence or non-occurrence of an event identified as a result of monitoring a computer system.

In another embodiment, an SMC process including best practices instructions for the implementation of an SMC facility is provided in a hierarchical manner comprising a plurality of top level activities to be performed during the operation of the SMC, with each of the plurality of top level activities being described as comprising at least one lower level sub-action. The hierarchical approach provides IT operations with a comprehensible framework with which to establish, assess, maintain and optimize an SMC facility.

In another embodiment, a method of operating and instructing operators to operate an SMC facility includes involving software developers in the SMC process. The software developer is often the person in the best position to provide certain monitoring, diagnostic and control information to an SMC facility. For example, the software developer is in control of what interfaces are exposed to the external world. However, the software developer may not be in a position that affords the best understanding of what information is most useful from an IT operations point of view. Accordingly, a more effective SMC facility may be implemented by having IT operations communicate with software developers, so that IT operations can request that changes be made to the software to improve the information that is available to an SMC facility.

In another embodiment according to the present invention, a method of operating and instructing operators to operate an SMC facility includes self optimization techniques. Changes to one or more parameters of the SMC facility may be automatically assessed and/or automatically implemented. By employing automatic assess and implement capabilities, an SMC facility may improve its performance and monitoring capabilities, at least in part, without operator involvement.

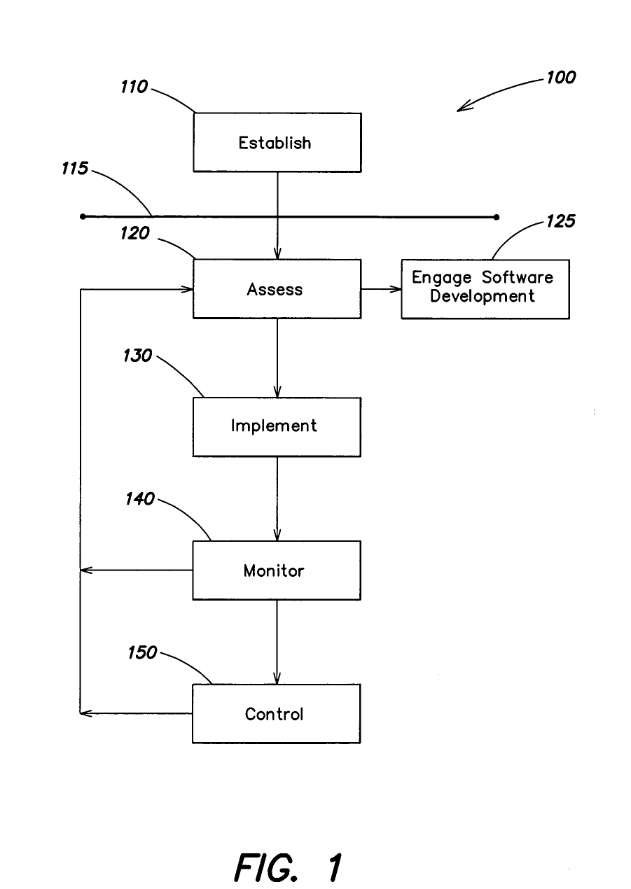

FIG. 1 illustrates a flow diagram of an SMC process 100 for implementing an SMC facility in accordance with one embodiment of the present invention. SMC process 100 includes a plurality of top level activities that describe process 100 at a high level. The top level activities include establishing the SMC facility, assessing performance of the SMC facility, implementing at least one change in the SMC facility in response to information learned during assessing the performance of the SMC facility, monitoring the computer system with the changed SMC facility for an occurrence of at least one event, and automatically performing at least one control action in response to the occurrence of the at least one event.

The establish activity 110 may include various actions involved in understanding a particular computer system and determining what portions of the system should be monitored. The establish activity may include collecting information on and identifying aspects, characteristics and components of the computer system on which the SMC facility is being implemented. For example, the establish activity may include identifying the various applications that will run on the computer system, collecting information on the protocols, network, security, and other facilities that form the operational backbone of the computer system, etc.

A result of the establish activity may include a database (electronic or otherwise) of available resources and services to be monitored, interfaces and hooks provided by software, attributes of component parts of the computer system infrastructure that are to be monitored, and a definition of how monitoring is to be enacted. The monitoring definition may include such things as setting rules as to how the SMC facility will behave on the occurrence or the non-occurrence of particular events. The term “event” is used herein to describe any detectable happening. For example, an event may be an exception condition thrown by one or more software components executed on the computer system, a status indicator, flag, or any other occurrence that can be received and/or obtained by IT operations, either manually or by software (e.g., management tools) operating on the computer system.

Events are often exposed by software via an interface. The term “interface” is used herein to describe one or more entry points provided by a software component or module that allows access to or provides information about the software component. A software component's interface may include functions, methods, or any other of various hooks that permit one or more other software components to obtain information about the software component, including, but not limited to, state variables, exception conditions, diagnostic information or any other information related to the internal status of the software component. A software component's interface may also include any messaging mechanism by which the software component reports events, error conditions, status indicators, etc.

In some embodiments, the establish activity may include defining a health specification or health model. The term “health specification” or “health model” refers herein to a definition or description of a service, application, hardware or software component, computer system, etc., as it relates to correct and/or incorrect operation thereof. A health specification relates to an SMC facility and may be defined by IT operations, and a health model relates to components operating on a computer system and may be defined by the designer or developer of the component. For example, IT operations may build a health specification based on one or more health models provided by developers of software components operating on the computer system.

As discussed above, conventional service monitoring often fails because IT operations may be unaware of what constitutes anomalous operation and/or degraded performance. A health model may facilitate a better understanding by defining healthy states and degraded states for the component. In addition, a health model may include a description of the severity of a degraded state and/or measures or remedial actions to take to transition from a degraded state to a healthy state or from a severely degraded state to a less degraded state.

IT operations may then define a health specification from the one or more health models that describe the health of the computer system using any of the various description techniques described above. It should be appreciated that a health specification may be established without the benefit of or in the absence of one or more health models. IT operations may define a health specification that, for example, describes healthy and degraded states, defines transitions between states, and/or provides remedial actions to make those transitions, for a SMC facility from any information that is available to IT operations. The health specification facilitates an understanding of when a computer system is operating correctly or anomalously, and how degraded performance may be remedied.

As shown in FIG. 1, the establish activity is separated from the other various top-level activities of SMC process 100 by run-time line 115. Activities above run-time line 115 are part of a preparation and deployment stage. Typically, activities during the preparation and deployment stage are completed before operation of the SMC facility to define and construct the SMC facility, or such activities can be performed before planned modifications to an existing SMC facility. Accordingly, the establish activity may be performed in preparation for implementing an SMC facility. In some circumstances, a computer system implementing an SMC facility may undergo substantial changes, such as addition of significant new services and/or componentry, or the operation or functionality of the computer system may substantially change. Under such circumstances, the top level establish activity may be repeated for the modified computer system.

In other circumstances, a computer system may have (at some level) a monitoring and control environment in place. To provide a robust SMC facility, the top-level establish activity may be performed for the currently existing (and operating) computer system. However, in an alternate embodiment, the establish activity may be skipped for computer systems having an already deployed monitoring facility.

SMC process 100 further includes a top level assess activity 120. The assess activity may include any of various tasks involved in evaluating how well the SMC facility defined during the establish activity 110 (or as previously established) operates in practice. A purpose of the assess activity is to review and analyze the current conditions of an operating SMC facility to identify and determine adjustments to any of the various aspects of the SMC facility that may be appropriate. As shown in FIG. 1, the assess activity appears below run-time line 115. As such, the assess activity may be an ongoing analysis that facilitates changing and optimizing the SMC facility throughout the lifetime of the computer system on which the SMC facility is implemented.

The assess activity may be performed when a new service or function of the computer system is introduced, and/or continuously or periodically during operation of the SMC facility at any desired frequency. For example, a change in the infrastructure of the computer system may result in the addition of one or more services to monitor. In addition, new applications or services may expose additional interfaces, status identifiers, error conditions, etc., that may be added to the set of rules and definitions describing the SMC facility, and/or may be incorporated into the health specification of the SMC facility. Continuously performing the assess activity may help to understand the impact of different variables, operating conditions and states of the computer system that may arise during operation, such that additional strategies to handle the various conditions may be developed and implemented in subsequent activities of the SMC process.

In one embodiment, the assess activity may be integrated with a top level activity of engaging the software development team 125. Many monitoring facilities fail and/or operate sub-optimally because IT operations and software developers have little or no communication with one another. As a result, IT personnel must operate an SMC facility with whatever resources and interfaces happen to have been made available by the software developers when the software running on the system was developed. By including software development in the SMC process, IT personnel (who are often in the best position to identify and determine what resources, interfaces, error conditions, etc., are desired) may request that software developers expose particular interfaces, or make certain information available that will facilitate operating a more effective SMC facility. Opening the communication channels between IT operations and software development may facilitate the design and subsequent implementation of an optimal SMC facility. While the high level activity of engaging the software development team can be advantageous for the reasons discussed above, the present invention is not limited in this respect, as this activity is not necessary to produce some embodiments of the invention.

In one embodiment, one or more of the assess activities may be performed automatically. Diagnostic reports generated during the monitoring and/or control activities described below may be automatically analyzed. For example, one or more programs may process diagnostics to determine various information about the operation of the SMC facility. Such information as the number of times a particular parameter exceeds its threshold or operates outside a set tolerance may be computed, or how long a particular component operated in a healthy state. The information obtained may be used to determine automatically that one or more monitoring functions should be changed. For example, automatic assessment may determine that a threshold has been set too high or too low, or that a tolerance range is too accommodating. Server statistics may indicate that a particular service is receiving high volume. Automatic assessment may determine that additional monitoring capabilities may be needed to insure that the service doesn't malfunction or become overloaded. Automatically assessing the SMC facility may promote a computer system capable of, to some extent, optimizing itself, optimally in conjunction with the activity of engaging software development.

SMC process 100 further includes a top level implement activity 130. Initially, the implement activity implements the various monitoring capabilities designed during the established activity. Subsequently, the implement activity includes enacting changes to the SMC facility identified during assess activity 120. In addition, the implement activity may include incorporating any new monitoring capabilities that were made available by software developers during the software developer engagement activity 125. For example, during performance of the assess activity, it may be determined that certain diagnostic output is too verbose, or particular events need not be reported. During the implement activity, the verbosity of those diagnostics and/or the unnecessary events may be suppressed. On the other hand, the analysis performed during the assess activity may indicate that new or further events would benefit from monitoring, or particular conditions should be addressed in a different fashion. Accordingly, during the implement activity, each of the identified changes to the SMC facility may be put into action.

In one embodiment, one or more of the SMC functions may be implemented automatically. As described above, automatic assessment may facilitate an SMC environment having self-healing characteristics. While automatically generated assessment data may be implemented manually, it may be desirable to fully integrate a self optimizing SMC facility by having one or more changes to the SMC facility implemented automatically. For example, threshold values or tolerances identified (perhaps automatically) as needing modification may be automatically changed during the implement activity. Monitoring capabilities may be automatically achieved, for example, by having a program or script automatically update one or more SMC tools to add or remove identified monitoring capabilities.

SMC process 100 further includes a top level monitor activity 140. The monitor activity includes the activation of the SMC facility. In particular, the monitor activity includes the actual operation of the various service monitoring functionality and capabilities that were established, assessed, and implemented in the previous top level activities of the SMC process 100. The monitor activity may include obtaining/receiving events, conditions, status indicators, etc., from various components and services of the computer system and evaluating them against the various rules set forth in the establish activity. The monitoring activity may include, for example, producing diagnostic output such as a dynamic console that indicates the health and/or performance of the computer system for the various services being monitored. In addition, the monitoring activity may include identifying when a failure condition has occurred and/or when the system is behaving anomalously. Both the responsibility of identifying and reporting may constitute significant operations of the monitoring activity. When a failure condition, or an anomalous event is identified, or an unhealthy state is entered, the SMC facility may transition to top-level control activity 150.

Control activity 150 may include any response to an event that has been defined as requiring a remedy (e.g., by rules set forth in the establish activity and/or according to the health specification). In one embodiment, control activities can be taken automatically, which refers herein to actions, tasks and/or procedures that are performed substantially without human intervention or involvement. For example, a script and/or a program that is executed upon the occurrence or non-occurrence of a particular event is considered automatic. However, scripts launched or programs executed as a result of human initiative, such as an administrator indicating through an interface that a particular action should take place is not considered automatic.

The control activity may include any of various responses and may facilitate implementing remedial actions that would otherwise require an IT administrator or personnel to intervene. Such automated responses enable an SMC facility to handle many of its problems and recover from failures such that the computer system, as a whole, has a higher rate of availability than would a computer system requiring an IT administrator to manually remedy such conditions when they arise. While some control activities may be remedial, others may be performed routinely, such as starting an application at a particular time each day on a particular node in the system.

In one embodiment, the activities below run-time line 115 may be performed repeatedly (e.g., in a loop). For example, information such as diagnostic reports, network activity, server load, application performance, etc. generated during the monitoring activity may be evaluated by operations in a periodic or substantially continuous assessment of the SMC facility. Similarly, problems and/or optimizations to the SMC facility identified during performance of the assess activity may be implemented in the SMC facility. The newly implemented service monitoring and control functions then may be put into operation to generate both new feedback with regard to the SMC facility and new automatic controls such as remedial actions, notifications and alerts, etc. By performing SMC process 100 (at least below run-time line 115) throughout the lifetime of the computer system, the SMC facility implemented on the computer system may be optimized over the course of time. In addition, changes to the infrastructure of the computer system and/or additions or removal to various services provided by the system may be integrated into the SMC facility such that the SMC facility performs in a generally optimal manner.

SMC process 100 illustrates one embodiment of a top level abstraction of a best practices process for defining and implementing an SMC facility. To provide an easily comprehensible process for IT personnel of various levels of experience, and to provide a structure that is understandable and meaningful in implementing a robust and stable SMC facility, further sub-activities within each of the top level activities may be provided in accordance with one embodiment of the invention.

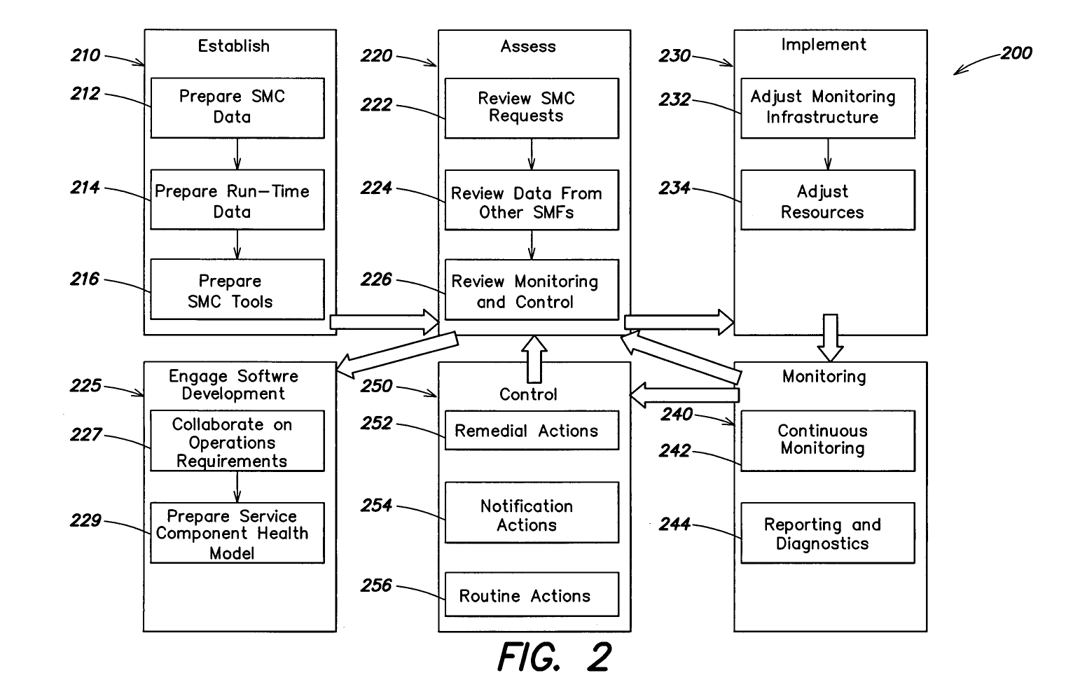

FIG. 2 illustrates the top level activities similar to those described for SMC process 100 of FIG. 1, including establish activity 210, assess activity 220, engage software development 225, implement activity 230, monitoring activity 240, and control activity 250. Each of the top level activities includes one or more sub-activities that further refine the process for developing an SMC facility in accordance with one embodiment of the invention. While the further subdivision of each of the top level activities into the specific sub-activities shown in FIG. 2 is advantageous for the reasons discussed below, it should be appreciated that the present invention is not limited in this respect, as the top level activities can be subdivided into any suitable sub-activities.

Top level establish activity 210 comprises sub-activities including prepare SMC data 212, prepare run-time data 214, and prepare SMC tools 216. Actions of the prepare SMC data sub-activity may include collecting data about a computer system relevant to developing an SMC facility, determining what portions of the computer system are to be monitored (e.g., services, software components, etc.), creating a health specification for the SMC facility, etc.

For example, for a particular service being monitored, each of the accessible and/or available parameters, conditions, status indicators, (e.g., information provided by an exposed interface) etc. that are to be monitored may be given acceptable ranges of values under which the service is to be considered as operating normally and rules may be defined to describe actions to be taken when those tolerances are exceeded. Likewise, a health specification may include various conditions, events, and/or values of parameters that indicate that the service is operating in a degraded or unhealthy state and the steps that should be taken to remedy or transition out of the unhealthy state. As discussed in further detail below, a health specification may include such things as known transitions that a service can potentially go through during its life cycle, methods of recovering from unhealthy states, indications of the severity of an unhealthy state, etc.

The health specification seeks to define what type of information should be provided and how the system or the administrator should respond to that information. For example, the health specification may define such management instrumentation such as events, traces, performance counters, objects/probes that may facilitate detection, verification, diagnosis, and recovery from bad or degraded health states, etc. The term management instrumentation refers to the collection of capabilities that an SMC facility has for implementing monitoring and/or control and may include interfaces exposed by various software components, control functions, SMC tools, etc. The health specification may define dependencies, diagnostic steps, and recovery actions and may identify conditions requiring intervention from an administrator. A health specification should be flexible such that it can incorporate feedback from customers, product support, testing resources, and/or automatic remedial actions taken during a control action.

The prepare run-time data sub-activity 214 includes activities for the implementation of the SMC facility. For example, activities may include training IT staff or personnel, defining their roles, and generally establishing the IT infrastructure, as it relates to the personnel, that will enable stable and robust implementation and operation of an SMC facility for a current computer system as well as changes to a future computer system as the system evolves. Preparing run-time data may also include establishing communication channels amongst operations and between operations and providers of components, software, hardware and other infrastructure comprising the system, and insuring that participants understand their roles and tasks within the IT organization.

Establish activity 210 also includes a prepare SMC tool sub-activity 216. This sub-activity may include researching and identifying the tool requirements of the SMC facility based on the various considerations of the environment of the computer system. Given that purchasing of inappropriate monitoring tools is often a pitfall of conventional SMC facilities, understanding the capabilities such as the scalability and extensibility of the monitoring tool, the needs of a particular computer system, etc., may facilitate establishing a robust, flexible and scalable SMC facility.

Assess activity 220 comprises a number of sub-activities including review SMC requests 222, review data from other service management functions (SMFs) 224, and review monitoring and control 226. Sub-activity review SMC requests 222 include assessing the various requests issued to the different factions of an IT organization. For example, a request may include such things as a request to suspend monitoring, restart monitoring, change monitoring parameters, etc. A change in monitoring parameters request may be generated from operations and issued to change management for routine changes or to problem management for break/fix situations. Examples of change monitoring parameters include threshold changes such as changing a specific threshold that determines when an alert is triggered, frequency changes that change the sampling interval that an SMC tool polls a particular service, resource or component, and rule changes including changes to individual rule sets that define the processing of an event or the description of various triggers. Change monitoring parameters may also include the removal of monitoring. For example, when an infrastructure component is removed from the enterprise system, the associated monitoring of that component may be requested for removal. The review SMC requests 222 may include a general review of all the requests active in the SMC facility.

Sub-activity review data from other SMFs 224 may include reviewing data received from other areas of IT, or other groups such as software development, patch management, and other processes involved in operating a computer system as it relates to SMC. This may include reviewing security administration, directory services administration, network administration, etc. Previewing data from other SMFs insures that the SMC facility is operating correctly and to the expectations, and according to the agreement between the various groups involved in the operation of the computer system. For example, in one embodiment, it is contemplated that the computer system being monitored, and the SMC facility, may be operated according to the Microsoft Operations Framework (MOF). In that embodiment, sub-activity 220 may include reviewing data from other MOF SMFs implemented on the computer system.

Sub-activity review monitoring and control 226 may include an analysis of how well monitoring and control is operating. For example, analysis may include examination of the health specification to determine whether the rules describing health states, transitions between health states, and remedial rules to transition the system from unhealthy or degraded states, are sufficient and exhaustive enough to adequately maintain a healthy SMC facility during actual operation of the computer system. Review and monitoring control sub-activity may also include assessing SMC tool components, for example, analyzing the operation of various management tools to insure that they are integrated properly, and to identify and/or determine places where the tool components may be improved. For example, response rules, alerts, and/or notifications, polling rates, and other monitoring services provided by the various SMC tool components integrated into the computer system may be assessed to determine that they are operating properly. It should be appreciated that one or more of the assess actions described above may be performed automatically.

Engage software development activity 225 comprises sub-activities including collaborate on operations requirements 227 and prepare service component health model 229. Collaborate on operations requirements 227 may include providing feedback to internal software development, and/or external software development to improve overall manageability of the SMC facility. For example, operations and software development may collaborate to influence subsequent versions of a particular application or software component providing a service. Such collaboration may include activities such as validating the management instrumentation such as events and conditions provided by an interface to make sure that such conditions actually exist. In addition, operations may provide feedback on the reliability and consistency of the instrumentation and provide suggestions for the potential correction and improvement to one or more interfaces provided by the software to improve the overall capability of the management instrumentation.

In addition, sub-activity 227 may include activities such as discussing with software development one or more aspects of the health specification and requesting certain information from the software developers such that the health specification is sufficiently supported. The efficacy of the health specification may rely, in part, on the ability of operations and software development to maintain a channel of communication such that the appropriate and/or optimal information such as events, traces, performance counters, etc. are available to operations.

Sub-activity prepare service component health model 229 may include instructing and collaborating with developers to define health models for the software, such as various service components that they develop. As discussed above, well defined health models may facilitate creation of more effective health specifications. In addition, sub-activity 229 may include collaboration between operations and software development with respect to improving an existing health model, for example, so that the health model is a more accurate description of the service component as it applies to its actual operations.

Implement activity 230 comprises a plurality of sub-activities including adjust monitoring infrastructure 232 and adjust resources 234. Adjust monitoring infrastructure 232 may include various actions involved in changing how the monitoring system operates to cure any deficiencies identified during the assess activity. For example, any changes made to the health specification may be reflected by implementing corresponding changes to the rules and responses of the SMC facility. New thresholds, ranges and/or tolerances for the various parameters of the monitoring system identified during the assess activity may be implemented. For example, the various SMC tools comprising the SMC facility may be adjusted such that the changes to the SMC facility determined in the assess activity are implemented.

Sub-activity adjust resources 234 may include any activity involved in changing the computer system infrastructure, such as adding or removing a component, adding or removing a service, and/or modifying, adjusting or configuring the computer system itself. For example, sub-activity 234 may include consolidating one or more servers and removing any unnecessary equipment. Similarly, sub-activity adjust resources 234 may include adding additional equipment to the computer system. For example, additional servers may be added at a remote location to provide a backup node and/or to provide redundant services in case a primary location fails. It should be appreciated that one or more of the above implement activities may be performed automatically.

Monitoring activity 240 includes sub-activities of continuous monitoring 242 and reporting and diagnostics 244. Sub-activity 242 may include the real-time observation of the health of the computer system by activating SMC facility and monitoring the available management instrumentation. Sub-activity reporting and diagnostics 244 may include various actions involved in documenting the operation of the SMC facility and the computer system. For example, various diagnostic reports such as event logs, reports on server and network loads, listing of error conditions encountered, time spent in healthy and unhealthy states, etc., may be generated during sub-activity 244. The reporting sub-activity may be important in facilitating subsequent effective and meaningful assess activities.

Control activity 250 includes sub-activities remedial actions 252, notification actions 254 and routine actions 256. Remedial actions 252 may include any task designed to recover from an error, respond to an event to fix a problem, transition the computer system to a healthier state, etc. For example, a script or program may be automatically launched when monitoring identifies that a certain event has occurred. For example, monitoring activities may identify that the load on a server providing one or more services has exceeded the established threshold value. In response, a program configured to switch one or more services from one server to another may be launched as part of remedial actions 252.

Notification actions 254 may include any automatic task executed to alert IT or other personnel of the occurrence of an event, error condition, etc. Notification may include automated tasks such issuing an automatic e-mail, page, telephone call, fax, etc., to IT operations, or may indicate a warning via a control console coupled to the computer system. Notification actions 254 may alert one or more operators such that further remedial actions, if necessary, may be carried out manually.

Routine activities 256 may include any of various tasks that are automatically performed to maintain the operation of the SMC facility. For example, an automatic script may be employed to daily execute one or more monitoring facilities to be active during certain hours of the day and terminate the facilities at some later desired point in time. Other routine activities may include generated daily diagnostic reports and distribution to desired members of an IT organization, or any other function that operates automatically on a regular basis that is generally independent of the state of the SMC facility and/or health of the computer system.

It should be appreciated that one or any combination of sub-activities may be implemented in an SMC facility in any combination. Implementing an SMC facility is not limited to performing each of the activities described above and may be performed using one or any combination of activities and/or sub-activities. In some SMC facilities, one or more activities may not be necessary or desirable and may not need to be performed.

The Microsoft Operations Framework (MOF) provides guidance that enables organizations to achieve system reliability, availability, supportability, and manageability for a wide range of management issues pertaining to complex, distributed, and heterogeneous environments. MOF includes a number of service management functions (SMFs) that provide operational guidance for implementing and managing computing environments and other IT solutions. In one embodiment, instructions in implementing an SMC facility is provided as a MOF SMF, although embodiments of the invention described herein are not limited to use with MOF. The SMC SMF is presented in accordance with the fundamental principles of MOF and may be fully integrated with other MOF SMFs. A complete description is provided in the published Microsoft Service Monitoring and Control (SMC) Service Management Function (SMF) documentation, which is herein incorporated by reference in its entirety.

In one embodiment, the Service Monitoring and Control (SMC) service management function (SMF) is responsible for the real-time observation and alerting of health (identifiable characteristics indicating success or failure) conditions in an IT computing environment and, where appropriate, automatically correcting any service exceptions. SMC also gathers data that can be used by other SMFs to improve IT service delivery.

By adopting SMC processes, IT operations is better able to predict service failures and to increase their responsiveness to actual service incidents as they arise, thus minimizing business impact.

There are several underlying factors why effective service monitoring and control is increasingly important, these include:
Business Dependency. Organizations are increasingly reliant on IT infrastructure and IT services, and IT's role in business delivery continues to expand. With this dependency, IT customers have greater exposure to IT failures, which often have severe impact to critical business functions.
Business Investment. Many organizations have realized the competitive advantage that IT provides and have made substantial investments in IT infrastructure. This forces a greater demand for demonstrable immediate return on investment (ROI) and the delivery of continuous long-term benefits.
Technology Complexity. As the IT Infrastructure continues to become larger and more distributed, it becomes more difficult to understand all the intricate requirements necessary to keep the IT infrastructure in good condition.
Business Change. Business-side changes have the potential to cascade to much larger tactical shifts in IT infrastructure. With business-side imperatives changing directions at a much faster pace, there is an increased demand to shorten IT technology delivery life cycles, increase architecture agility, and make better use of tools. The key benefits of effective service monitoring and control are:
Early identification of actual and potential service breaches.
Rapid resolution of actual and potential service breaches through the use of automated corrective actions.
Minimized business impact of incidents and potential incidents.
Reduction in actual service breaches. Availability of up-to-date infrastructure performance data. Availability of up-to-date service level and operating level performance data.
Continued alignment of the monitoring performed and the business requirements.
Continued evolution of monitoring to meet business and technological change.
Maximized usage of management tools through effectively planned and integrated processes.

SMC provides the above benefits by carrying out the following six core processes, which are described in detail in the following sections:
Establish
Assess
Engage Software Development
Implement
Monitor
Control

Introduction

Document Purpose

This guide provides detailed information about the Service Monitoring and Control service management function for organizations that have deployed, or are considering deploying, monitoring tools technologies in a data center or other type of enterprise computing environment.

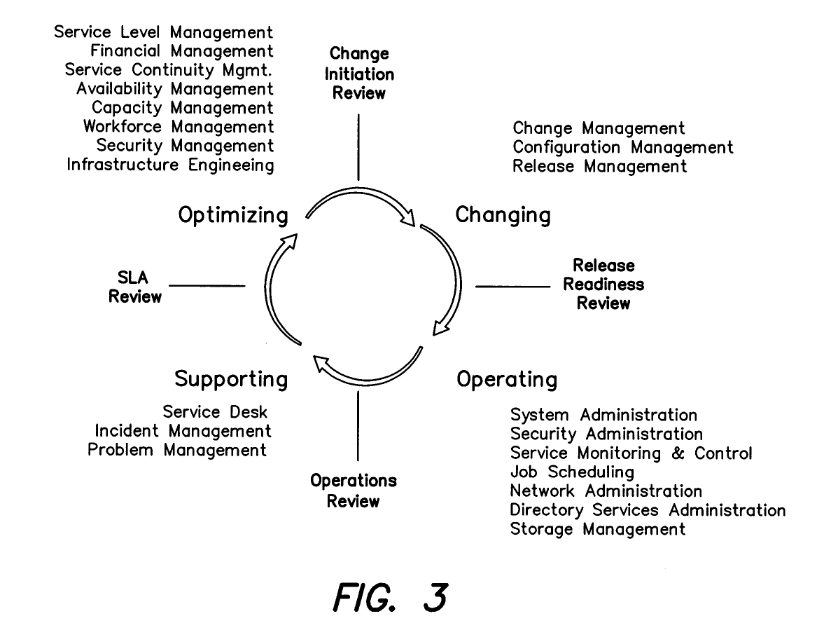

This is one of the more than 21 SMFs (shown in FIG. 1) defined and described in Microsoft® Operations Framework (MOF). Every SMF within MOF benefits from some aspect of SMC because these functions are inherent to ongoing process improvement. This is especially true in the Operating Quadrant of the MOF Process Model where the SMFs are closely interrelated. FIG. 3 illustrates the MOF Process Model and Related SMFs.

The guide assumes that the reader is familiar with the intent, background, and fundamental concepts of MOF as well as the Microsoft technologies discussed. An overview of MOF and its companion, Microsoft Solutions Framework (MSF), is available in the Overview section of the MOF Service Management Function Library document. This overview also provides abstracts of each of the service management functions defined within MOF. Detailed information about the concepts and principles of each of the frameworks is also available in technical papers available at www.microsoft.com/mof.

The SMC guidance contained in this document has been completely revised to include updated material based on new Microsoft technologies, MOF version 3.0, and, ITIL version 2.0. The SMC SMF now has more in-depth information for establishing an effective monitoring capability, including upfront preparation such as noise reduction. It also includes more complete information on run-time activities necessary to continuously optimize the monitoring process, its artifacts, and deliverables.

Service Monitoring and Control Overview

Goals and Objectives

The primary goal of service monitoring and control is to observe the health of IT services and initiate remedial actions to minimize the impact of service incidents and system events. The Service Monitoring and Control SMF provides the end-to-end monitoring processes that can used to monitor services or individual components.

Service monitoring and control also provides data for other service management functions so that they can optimize the performance of IT services. To achieve this, service monitoring and control provides core data on component or service trends and performance.

The successful implementation of service monitoring and control achieves the following objectives:
Improved overall availability of services.
Greater focus on service availability rather than component availability, resulting in a reduction in the number of SLA and OLA breaches.
An improved understanding of the components within the infrastructure that are responsible for the delivery of services.
A corresponding improvement in user satisfaction with the service received. Quicker and more effective responses to service incidents.
A reduction or prevention of service incidents through the use of proactive remedial action.

The service monitoring and control function has both reactive and proactive aspects. The reactive aspects deal with incidents as and when they occur. The proactive aspects deal with potential service outages before they arise.

Scope

The Service Monitoring and Control SMF monitors and controls the entire production environment and works with the business, third parties, and the following SMFs to identify specific service monitoring and control requirements for their areas:
Capacity Management
Service Level Management
Availability Management
Directory Services Administration
Network Administration
Security Administration
Job Scheduling
Storage Management
Problem Management

Once the relevant requirements have been identified and agreed on with the SMC manager (see Chapter 5, “Roles and Responsibilities”), an ongoing program of proactive monitoring and controlling processes is implemented. These processes identify, control, and resolve IT infrastructure incidents and system events that may affect service delivery.

The service monitoring and control process interacts with the incident management process to ensure that data on automatically resolved faults is available to incident management and that any situations which cannot be immediately addressed using the automated control mechanism are directly forwarded to incident management for proper handling. This is of particular importance to the staff performing the incident management and problem management processes since more service incidents are generated using SMC than come directly from affected end users.

Service monitoring and control also deals with the suspension, in a timely and controlled manner, of the monitoring and control process for a particular configuration item or service. It specifically works with the Release Management and Change Management SMFs in order to minimize the impact to the business.

Any infrastructure that is deemed critical to the delivery of the end-to-end service should be monitored, usually to the component level. Some requirements, however, may prove impossible or impractical to meet, and so the initiator and the monitoring manager must agree on what is to be monitored before monitoring begins.

Service monitoring and control is the early warning system for the entire production environment. For this reason, it exerts a major influence over all areas of the IT operations organization and is critical to successful service provisioning.

Core Concepts

Readers should familiarize themselves with the following core concepts, which will be used throughout the SMC guide.

Service

Service Definition

In the context of the Service Monitoring and Control SMF, a service is a function that IT performs for or with the business. A service is defined from the business organization's point of view. For example, e-mail and printing may each be considered a service, regardless of the number of lower-level components or configuration items (CIs) required to deliver the service to the end user.

In Microsoft Windows® technology terms, a service is a long-running application that executes in the background on the Windows operating system. These services typically perform working functions for other applications. In this SMF, this type of service will be referred to as a Windows service, an application service, or a server process.

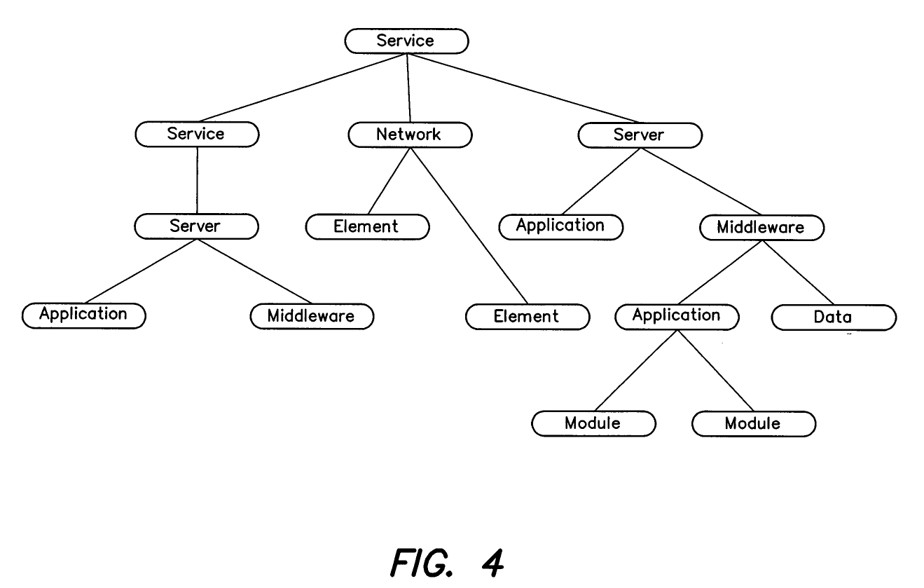

Services in use within an organization are recorded in the service catalog. The service catalog is created and managed by the Service Level Management SMF. It includes a decomposition of services to its supporting infrastructure called service components. FIG. 4 illustrates a service component decomposition.

Service Components

Service components are configuration items (CIs) listed in the CMDB. These are atomic-level infrastructure elements that form the decomposition of a service. Service components that have instrumentation and can be used to determine health are observed and interrogated in order to assess the overall health of a service.

Microsoft has also developed the System Definition Model (SDM), which businesses can use to create a dynamic blueprint of an entire system. This blueprint can be created and manipulated with various software tools and is used to define system elements and capture data pertinent to development, deployment, and operations so that the data becomes relevant across the entire IT life cycle. For more information on the SDM and the Dynamic Systems Initiative (DSI), please refer to http://www.microsoft.com/DSI.

Instrumentation

Instrumentation is the mechanism that is used to expose the status of a component or application. In most cases, instrumentation is an afterthought for both packaged and custom applications, so it is not exposed properly. For example, events are frequently not actionable and lack context, or performance counters often do not show what users need in order to identity problems. In addition, few components or applications expose management interfaces that can be probed regularly to determine the status of that application.

Health Model

The Health Model defines what it means for a system to be healthy (operating within normal conditions) or unhealthy (failed or degraded) and the transitions in and out of such states. Good information on a system's health is necessary for the maintenance and diagnosis of running systems. The contents of the Health Model become the basis for system events and instrumentation on which monitoring and automated recovery is built. All too often, system information is supplied in a developer-centric way, which does not help the administrator to know what is going on. Monitoring becomes unusable when this happens and real problems become lost. The Health Model seeks to determine what kinds of information should be provided and how the system or the administrator should respond to the information.

Users want to know at a glance if there is a problem in their systems. Many ask for a simple red/green indicator to identify a problem with an application or service, security, configuration, or resource. From this alert, they can then further investigate the affected machine or application. Users also want to know that when a condition is resolved or no longer true, the state should return to “OK.”

The Health Model has the following goals:
Document all management instrumentation exposed by an application or service.
Document all service health states and transitions that the application can experience when running.

Determine the instrumentation (events, traces, performance counters, and WMI objects/probes) necessary to detect, verify, diagnose, and recover from bad or degraded health states.
Document all dependencies, diagnostics steps, and possible recovery actions.
Identify which conditions will require intervention from an administrator.
Improve the model over time by incorporating feedback from customers, product support, and testing resources.

The Health Model is initially built from the management instrumentation exposed by an application. By analyzing this instrumentation and the system failure-modes, SMC can identify where the application lacks the proper instrumentation.

For more information on topics surrounding the Health Model, please refer to the Design for Operations white paper at http://www.microsoft.com/windowsserver2003/techinfo/overview/designops.mspx.

Health Specification

A Health Model is documented by development teams for internally developed software. It is also documented by application teams for software that has been heavily customized and extended.

A Health Specification is a set of documented information that is identical to the Health Model. However, this material is specifically created by IT operations (such as the SMC staff) and is designed for commercial off-the-shelf (COTS) software and other purchased service components.

Customer Impact

Having a strong understanding of service health allows instrumentation to be aligned with customer needs. Coupled with the monitoring and diagnostic infrastructures, this will allow administrators to quickly obtain the information appropriate to their circumstances. The guidelines contained in this guide on management instrumentation and documentation will ensure that the structured information delivered to the administrator is meaningful and that the appropriate actions are clear. These improvements will support prescriptive guidance, automated monitoring, and troubleshooting, which, in turn, will simplify data center operations, reduce help desk support time, and lower operational costs.

The more complete and accurate an application's model is, the fewer the support escalations that will be needed. This is simply because the known possible failures and corrective actions have already been described. With more automation, customers can manage a larger number of computers per operator with higher uptime.

In addition, the modeling documents created can be directly used in producing deployment, operations, and prescriptive guidance documents for customers when the product is released. (Please refer to the section on the Health Model for further information.)

Key Definitions

The following terms are used in the Service Monitoring and Control SMF. The definitions given here are used solely within the context of the SMC SMF.
Action/Response. A script, program, command, application start, or any other remedial response that is required. Typical actions are automated, operator-initiated, or operator-driven. Actions are generally defined to correct a system event that represents an incident within the IT infrastructure. However, actions can also be used to perform daily tasks, such as starting an application every day on the same node.
Alert. A notification that an operational event requiring attention may have occurred. An alert is generated when monitoring tools and procedures detect that something has happened (at the service, service function, or component level).
Control. Automated response or collection of responses. The three types of controls are diagnostic, notification, and interoperability.
Event. An occurrence within the IT environment (usually an incident) detected by a monitoring tool or an application that is consistent with predefined threshold values (within, exceeding, or falling below) that is deemed to require some sort of response or, at a minimum, is worth recording for future consideration.
Reporting. The collection, production, and distribution of an agreed-on level and quality of service information (for example, for use in capacity, availability, and service level management).
Resolution completion. The point in the control process where manual/automatic action has been taken and all recording and incident management actions have been successfully completed.
Rules. A predetermined policy that describes the provider (the source of data), the criteria (used to identify a matching condition), and the response (the execution of an action).
SMC Tool Agent. A component of the SMC tool, which typically resides on the managed node and is responsible for functions such as capturing events and executing responses. In some cases, SMC tools can also have agentless configurations.
Threshold/criteria. As used in the system and network management industry, a threshold is a configurable value above which something is true and below which it is not. Thresholds are used to denote predetermined levels. When thresholds are exceeded, actions may occur.

Processes and Activities

Implementation of the SMC SMF should follow the Microsoft Solutions Framework (MSF) life cycle for vision/scope or justification, planning, development, test or stabilization, and release. For complete project-focused implementation, organizations should use MSF guidance for SMC. This implementation should include iterative deployment, limited trials and pilot environments, and consistent use of the MSF Risk Management Discipline.

As a result of its monitoring and controlling activities, SMC enables IT service provisioning by monitoring services as documented in agreed-on service level agreements or other agreed-on or predicted business requirements. Monitoring is also performed against the service components of operating level agreements (OLAs) and third-party contracts that underpin agreed-on SLAs, where these are in place.

After SMC gathers, filters, and agrees on overall service requirements with the business, it then works with IT operations peers in service level management to identify the IT services and infrastructure components across each layer of the enterprise that deliver these requirements.

In order to gather the overall service requirements from the business, SLAs will be referenced, as well as composite OLAs and underpinning contracts as needed. The component level technical requirements for other SMFs are also agreed on in parallel. In many instances these will mirror the business requirements, but many technology-specific requirements, data collection, and storage requirements that require monitoring will also be identified. The layers that need monitoring generally include:
Application
Middleware
Operating system
Hardware
Networking and access
Facilities and environmentals

The IT infrastructure that delivers the agreed-on services is identified and decomposed into infrastructure components (that is, configuration items) that deliver each service. If a configuration management database (CMDB) is available, it can be used to identify the configuration items.

The attributes of each configuration item that need monitoring are also identified (for example, disk space on a server or memory usage) and a definition of what constitutes a healthy state is also established for each configuration item. The actions to be taken or the rules to be followed in the event that a criterion is met or a threshold exceeded are also defined.

Performance of the day-to-day monitoring and control process can begin only after these criteria or thresholds and rules have been configured within the monitoring toolset and then deployed and reviewed. These are critical to the successful operation of the process and to the delivery of high-availability services.

Continuous day-to-day monitoring against these set criteria identifies real incidents and system events across the IT infrastructure. When an incident or system event is highlighted, remedial action (that is, automated response) is started to ensure that agreed-on service levels continue to be met.

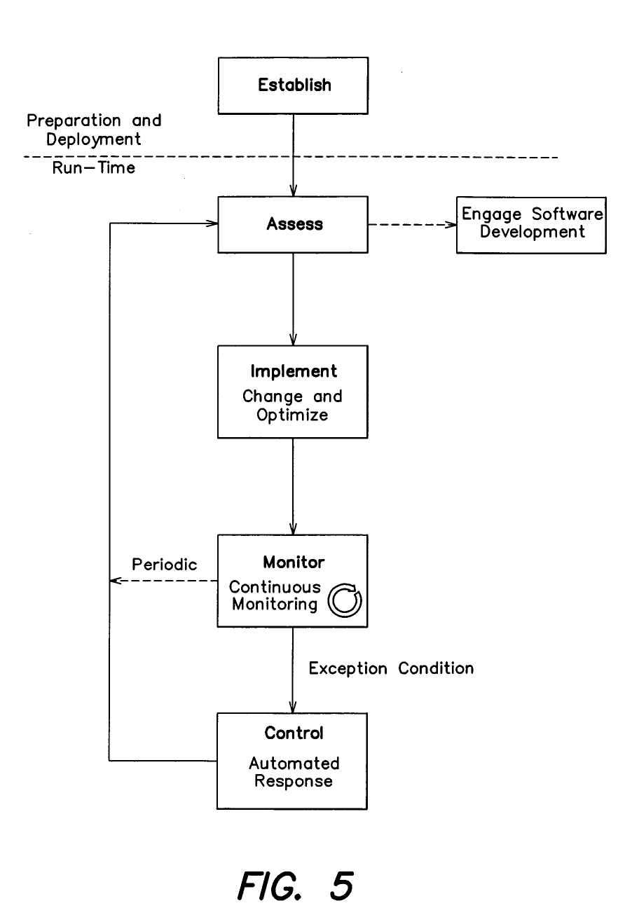

To fully adopt SMC, an IT operations organization may follow 6 core processes (shown in FIG. 5):
Establish
Assess
Engage Software Development
Implement
Monitor
Control

Each of these processes is described in detail in the following sections. FIG. 5 illustrates SMC core processes for one embodiment of the present invention.

Establish

Overview

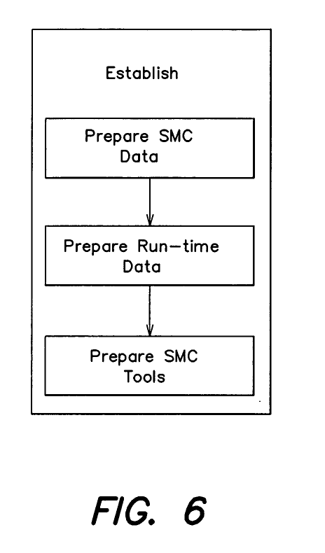

The Establish process collects, develops, and implements the foundational components of the Service Monitoring and Control SMF. The Establish process focuses on the initial setup of the SMC capabilities and is not part of the run-time workflow. FIG. 6 illustrates main activities of the Establish process. The Establish process is composed of three main activity areas:
Prepare SMC Data. The formalization of health information with the collaboration of other SMFs and line organizations.
Prepare Run-time Data. The establishment of SMC processes and roles.
Prepare SMC Tools. The identification and implementation of critical management technologies for SMC.

It is important for organizations to carefully execute all the steps in the Establish process. Organizations may go through multiple iterations of the Establish workflow throughout the MSF life cycle in order to achieve optimal process functionality and to fully experience the benefits from the investment in monitoring tools and technologies.

This Establish process can be used for companies that currently do not have a service monitoring and control function/process in place, or it can be used to update and improve an existing SMC management function.

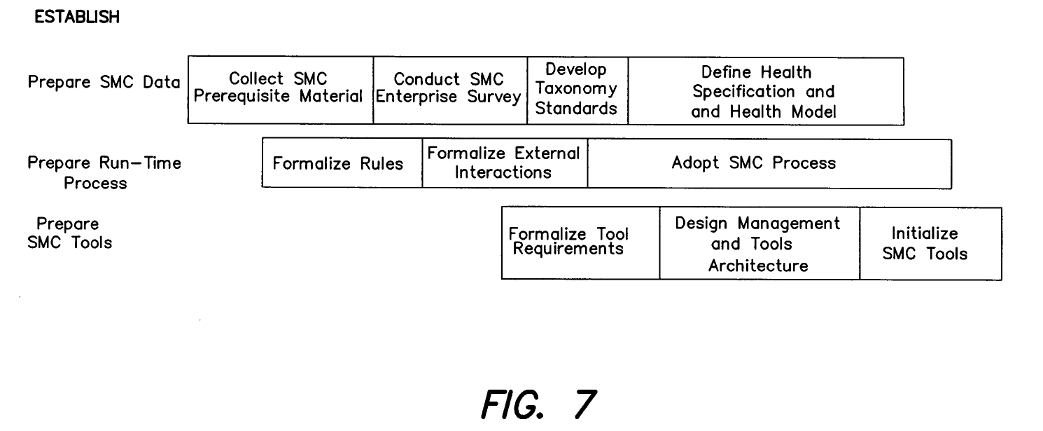

As shown in FIG. 7, the three main activities (and subactivities) in the Establish process can be performed both in sequence and in parallel with each other. This increases the efficiency of implementation and also saves time. The performance of some subactivities in the Establish process is dependent upon other subactivities being carried out as prerequisites. Examples of these dependencies are described below:
Prepare SMC Data: Conduct SMC Enterprise Analysis. This subactivity, in which resources are assigned and identified, should be carried out after the Prepare SMC Run-time Process: Formalize Roles subactivity.
Prepare Run-Time Process: Formalize Roles. This subactivity should be executed after preliminary information has been captured by the Prepare SMC Data: Collect SMC Prerequisite Material subactivity. When roles are being formalized and the base staff is being identified, the assessment data from the parallel activity will help to determine the number of personnel required, as well as their overall capabilities.
Prepare Run-Time Process: Adopt SMC Process. This subactivity requires that all material from the Prepare SMC Data activity, especially from the Collect SMC Prerequisite Material and Conduct SMC Enterprise Analysis subactivities, be completed prior to starting. This subactivity also requires integration based on the design created during the Prepare SMC Tools activity, especially the Create Management Architecture subactivity.
Prepare SMC Tools: Formalize Tool Requirements. This subactivity should be executed after information has been captured by the Prepare SMC Data: Collect SMC Prerequisite Material, Conduct SMC Enterprise Analysis, and the core components of the Develop Health Definition subactivities have been collected. This subactivity should involve any individuals assigned from the Prepare Run-Time Process: Formalize Roles subactivity.
Prepare SMC Tools: Create Management Architecture and Initialize SMC Tools. These subactivities should not be conducted until almost all of the core information from the Establish process has been collected.

Establish Process Activities

The following sections provide further details about each of the activities in the Establish process flow.

Prepare SMC Data

The objective of the Prepare SMC Data activity is to collect data used in all aspects of SMC, and to create detailed health specifications and models on the service components that need to be monitored and controlled by the SMC run-time process and tools. To effectively develop this material, a comprehensive review process must take place, as well as collaboration with other IT functions.

Collect SMC Prerequisite Material

Materials that aid with the implementation and optimization of service monitoring and control must be collected, categorized, and made accessible. A good place to start is with the key pieces of information that are generated or managed by other MOF SMFs.
Service Level Agreements (SLAs), Operating Level Agreements (OLAs), and Underpinning Contracts (UCs). These documents define the requirements and expected behaviors of IT services. This information typically includes targets on availability, continuity, and capacity; service hours; escalation; service level objectives; and associated metrics. This information is useful for SMC since it becomes the basis for monitoring thresholds. These documents also define the principal parameters to be used when reacting to exception conditions. These documents typically include information about escalation steps, hours of operation, and notification practices and will be used in SMC's Control process. Services and service conditions not listed in these agreements are typically not monitored by SMC. SLAs, OLAs, and UCs are created by the Service Level Management SMF. Further information about these documents is available at http://www.microsoft.com/mof.
Service Catalog. A service catalog hierarchically organizes an IT service (as defined in an SLA) into its requisite service components. Service components can be other services but, at an atomic level, are configuration items (CIs). This is important to SMC because actual monitoring is performed at the service component or CI level. Associating the CI or infrastructure being monitored, such as a server or application, to its parent service/s is the role of this document.
Problem Management Information. Knowledge generated by the Problem Management SMF is important to SMC. This body of knowledge, such as the Known Problem Base, is a collection of current and historical problems that have been investigated by problem management and includes a root cause analysis and possible workarounds. This material is useful to SMC especially when developing automated responses in the Control process.
Configuration Management Database (CMDB). The CMDB provides a single source of information about the components of the IT environment. The CMDB is created and managed by the Configuration Management SMF. This information is especially useful when developing class categorization and tools-specific rules for SMC infrastructure targets.
Incident Management and Service Desk Records. Knowledge generated by the Incident Management and Service Desk SMFs is typically presented in the form of a knowledge base. This information usually contains historical records of past incidents, categorizations, prioritizations, initial diagnostics, possible escalation steps, and eventual closure. This material is especially useful to SMC when developing health standards, defining roles, and developing management tools architecture.
Availability, Continuity, and Capacity Management Information. The SMFs in the Optimizing Quadrant—especially Availability Management, Continuity Management, and Capacity Management—generate important material including the methods for analysis and response to specific service level breaches. This material should be collected along with such other diagnostic models as dependency chain mappings, availability plans, and continuity plans. This information is especially useful when developing event rules.
Other Data Sources. Information not necessarily associated to specific SMFs can be collected from key individuals responsible for tracking infrastructure information. These individuals include network administrators, security administrators, systems architects, tools engineers, and system integration engineers.

Collaborate with Other SMFs

The process of collecting material from other SMFs provides a good opportunity to educate other service managers about the Service Monitoring and Control SMF and to explain the needs of the SMC SMF in terms of prerequisite materials. SMF materials that commonly need to be updated or improved for SMC include:
SLAs (including OLAs/UCs). These should be complete and enforceable. They should contain updated details on the current needs of the business, matched to realistic and measurable capabilities from IT. The agreements should also include service targets, the metric used to define the target, and how the target levels are obtained and calculated.
Service Catalogs. The service catalogs must directly correlate to the SLA. Services listed in the SLA must have a corresponding entry in the service catalog. The service catalog should also have detailed, granular, and—ideally—hierarchical enumeration of all service components and configuration items that constitute each service listed in an SLA.

Conduct SMC Enterprise Analysis

After the SMC prerequisite materials have been collected, a detailed survey and analysis should be made of the infrastructure and tools, management processes, and organizational structures and locations. This survey should validate the information that was collected from the other SMFs as well as increase the knowledge about the environment that will be managed by service monitoring and control.

Analyze IT Infrastructure and Service Catalog Decomposition

The SMC team should have a clear understanding of IT infrastructure's composition, especially the components that make up business-critical services. During this activity, any additional findings not already documented in the CMDB may be added with the coordination of configuration management. Key information that affects SMC architecture, design, and tools selection includes:
Hardware and Operating System. Document server types, versions, and sizing. Develop a high-level understanding of systems architecture, including future direction.
Cluster, Load Balancing, and Virtualization Configuration. Understand how work distribution technologies are adopted and used, including any special accommodations required for their use.
Network Configuration. Understand the use, path topology, and restrictions of the general network infrastructure. Some organizations may opt to create a dedicated management VLAN/subnet to ensure that management traffic is not affected by production loads. The SMC team must know how traffic that is relevant to SMC is prioritized, filtered, and routed. Network-related information may also come from the Network Administration SMF.
Security Model and Domain Design. This is important to understand because it will determine the user/group contexts: how the SMC tool will collect health information, how the data will be transported to the server, how the log information will be stored remotely, and how the control action will be authorized to make corrections. If the SMC tool does not have sufficient access to a service component, it will not be able to adequately interrogate to collect health state information and may also be unable to correct a breach condition (insufficient privilege).
Instrumentation Data Sources. Understand the instrumentation data source and protocols that applications and infrastructure use to expose their health conditions. This is important so that the appropriate tool and effective SMC architecture can be put in place in order to capture and incorporate the data. Common data sources may include:
Event log and performance counters
WMI
Log files

Simple Network Management Protocol (SNMP)
Syslog
Database records
Custom data sources

Common protocols may include:
RPC
DCOM
Specific UDP
Specific TCP

Analyze Infrastructure Management and Tools

Review the current process used to determine the short-interval (or real-time) health of the environment. An organization may not have a stand-alone process for this determination. Instead, it may be using an extended version of availability management and service level management monitoring. These current processes may provide additional information to help increase the successful adoption of SMC processes.

In addition, understand in-house and vendor-developed tools and scripts that are used to manage and control the environment. Their capabilities may be used to determine SMC tools requirements and/or be integrated into the SMC tool that will be deployed.

Analyze Organizational Design—Physical and Logical Distribution

A complete survey must be made of the organizational design and distribution of supporting IT staff. This information will be used in designing the SMC process adoption and, more importantly, the SMC tool architecture—especially the placement of consoles and servers and the forwarding and routing of events. For example, a centralized organizational model might require that alerts be forwarded to a centralized location where operators will be constantly available for monitoring the console. For more detail on organizational model considerations, please refer to the MSM Management Architecture Guide located at http://www.microsoft.com/technet/treeview/default.asp?url=/technet/itsolutions/msm/winsrvm g/mgmtarch/20/mgmtarc1.asp.

Collaborate with Key IT Line Organizations

During the Conduct SMC Enterprise Analysis activities, the SMC team should begin to establish a partnership with key IT line organizations. It is important to create these relationships to make sure that products from these teams will be addressable for monitoring and control within SMC's capabilities. The Establish: Prepare Run-Time Process: Formalize External Interactions activity will provide detailed information on furthering this relationship. The two most important groups to collaborate with include:
Software Development. This group constitutes development teams who create “homegrown,” or custom, business and IT applications. These teams can greatly benefit from SMC guidance on improving operations readiness for their developed applications and creating more effective instrumentation. In turn, the SMC team benefits from the collaborative effort, especially for SMC tool requirements, selection, and monitoring and control rules generation.
Application/Business Unit IT Teams. This group constitutes teams who select commercial off-the-shelf (COTS) applications and frameworks. This group may additionally extend or build new applications based on these frameworks. These teams greatly benefit from SMC guidance on selecting more operations-ready applications and improving operations readiness. Similar to the relationship with software development, the SMC team greatly benefits in this collaboration, especially for SMC tools requirements and selection, and monitoring and control rules generation.

Develop Taxonomy Standards

Taxonomy standards provide a common means for understanding health levels across all services managed with SMC. These standards may change and improve as additional infrastructure and tools are added under SMC's scope. For a detailed health model and definitions for the Windows operating system, please refer to the Design for Operations white paper at http://www.microsoft.com/windowsserver2003/techinfo/overview/designops.mspx.

Classification Standards

Classification standards are health attribute classes that categorize event-related information. Whereas incident management has a process to determine the classification of incidents as they occur, SMC's classification is predetermined for each event that is exposed by instrumentation. Incident management's sorting and identification process may help to define SMC's standard. Classification standards are important to SMC so that events and alerts are handled as effectively as possible on the basis of membership.

Classification standards include:
Event Tags. A classification of the operating state change when the event is triggered.

An example of an Event Tag Classification Standard is shown in Table 1 below.

TABLE 1

| Tag | Description |
|---|---|
| Install | The event indicates the installation or un-installation of an |
| | application or service within the service raising the event. |
| Settings | The event indicates a settings (configuration) change in |
| | the service. |
| Life cycle | The event indicates a run-time life cycle change (for |
| | example, start, stop, pause, or maintenance) in the service. |
| Security | The event indicates a change that is security related. |
| Backup | The event indicates a change that is related to backup |
| | operations. |
| Restore | The event indicates a change that is related to restore |
| | operations. |
| Connectivity | The event indicates a change that is related to network |
| | connectivity issues. |
| Low | This event is related or caused by low resource (for |
| resource | example, disk or memory) issues. |
| Archive | This event should be kept for a longer period for the |
| | purpose of availability analysis. (These events must be |
| | infrequent-for example, restarting the computer.) |

Event Types. A high-level classification of the type of event.

An example of an Event Type Classification Standard is illustrated in Table 2 below.

TABLE 2

| Event Type | Description | Examples |
|---|---|---|
| Administrative | Indicate a change in the health or | Started |
| events | capabilities of an application or the | Service stopped |
| | system itself, signaling a health-state | Database backup |
| | transition. | failure Severely |
| | | degraded |
| | | performance |
| Audit events | Indicate a security-related operation, | User logon |
| | including the result of an access | |
| | check on a secured object. | |
| Operational | Indicate state changes, such as | Counters installed |
| events | deployment, configuration, or internal | for application x. |
| | application changes. These might be | Thread pool |
| | of interest to an administrator for | increased to 50 |
| | debugging, auditing, or measuring | threads. |
| | compliance with a service-level | |
| | agreement (SLA). | |
| Debug | Code-level debugging statements that | Function x |
| tracing | are comprehensible only to someone | returned y |
| | with knowledge of the source code. | status code. |
| Request | Track application activity, response | HTTP Web |
| tracing | time, and resource usage within and | request. Search |
| | between parts of an application. | command on |
| | Activated for problem diagnosis. | database servers. |

Prioritization Standards

Prioritization standards are health attribute classes and types that define the taxonomy for urgency and impact. Whereas incident management has an evaluation process to determine the priority of incidents as they occur (on-demand), SMC's prioritization is predetermined for each event that is exposed by instrumentation. Incident management may already have an incident priority coding standard that SMC can adopt with minor tuning. Prioritization standards are important to SMC so that events and alerts are handled as effectively as possible on the basis of its membership to a specific taxonomy. This upfront definition is also critical so that events and alerts are uniformly classified. In other words, a level 1 designation for an event in application A and level 1 designation for an event in application B should both be equal in value or importance.
Severity Levels. This classification defines the impact of a specific event or alert on a component's ability to perform its function.

An example of a Severity-Level Prioritization Standard is shown in Table 3 below.

TABLE 3

| Severity | Description |
|---|---|
| Service | A condition that indicates a component is no longer |
| unavailable | performing its service or role to its users. |
| Security | A condition that indicates a security compromise has |
| breach | occurred and components are at risk. |
| Critical | A condition that indicates a critical degradation in health |
| | or capabilities. |
| Error | A condition that indicates a partial degradation in |
| | capabilities, but it may be able to continue to service |
| | further requests. |
| Warning | A condition that indicates a potential for future problems |
| | or a lower-priority issue requiring research. |
| Informational | A condition that has neutral priority and simply provides |
| | information. |
| Success | A condition that indicates a successful operation. |
| Verbose | A condition that has neutral priority and provides detailed |
| | information, typically from intermediate steps taken by |
| | the application in execution. |

Define Health Specification and Health Model

All the information collected and analyzed within the Prepare SMC Data activities is used to create a Health Specification for each service component. A Health Specification (also called a Health Model for internally developed software) documents significant information used for monitoring a specific component. This may include all actionable events, event exposure and behavior, and instrumentation protocols and behavior. Ideally, this information is directly codified into a language or configuration dataset that may be used by SMC tools. It is important to define taxonomy standards prior to documenting Health Specifications so that the specific attribute values related to classification and prioritization levels align to a common reference.

There are two types of Health Specifications:
Class-level. Creates specifications based on a class of common infrastructure or service components. In a large organization with a significant online presence using similar hardware and applications, an example may be a Health Specification for Web servers.
Override-level. Creates specifications based on individual infrastructure or service components that fall outside of a class grouping. In a large organization consisting mostly of databases using Microsoft SQL Server™, an example may be a Health Specification for a specific host running Microsoft Access.

For more information on how to create a Health Specification or Health Model, please refer to the “Steps in Building a Health Model” activity in the Engage Software Development process of this SMF guide.

Prepare Run-Time Data

The Prepare Run-Time Process activity includes key activities for the implementation of SMC's run-time process.

The successful implementation of the SMC process requires sustained executive commitment, training for SMC staff, and ongoing review, mentoring, and process optimization.
Executive Commitment. Sustained executive commitment to SMC must be established as early as possible—for example, during the vision/scope phase of SMC's project life cycle. Full SMC implementation will vary in length based on the size and diversity of the infrastructure and services being monitored, along with the desired level of automation for the Control process. Executive sponsors are needed to provide high-level advocacy, process authority, and funding; to arbitrate organizational disagreements related to SMC; and to enforce such standards as new release criteria as defined in the Engage Software Development process. For example, new release criteria may state that new applications being accepted by IT operations must include a Health Model as part of the release package.
Staff Training. SMC staff and related personnel should be familiar with fundamental MOF concepts and have proficiency with the SMC processes. Effective training will accelerate the adoption of SMC by the organization, and the new knowledge and skills gained by the staff will reduce SMC process issues.
On-going Review, Mentoring, and Process Optimization. The initial SMC implementation is based on the point-in-time conditions of a given environment, which will invariably change and evolve. Without a commitment to pursue ongoing improvement, an SMC SMF implementation will eventually break down and become ineffective.

Formalize Roles

In this subactivity of Prepare Run-Time Process, the SMC roles for the organization, including any minor company-specific nuances, are formally defined. Many organizations also use the role name as a job position or title. An example of a company-specific nuance may be the addition of numbering associated with pay or seniority level, such as SMC Operator 1 or SMC Operator 3. For a complete listing of standard SMC roles including their duties, please refer to Chapter 5, “Roles and Responsibilities.”

Where available, key individuals should be assigned SMC roles and become immediately involved in the Establish activities. This will help foster organizational learning and maintain continuity.

Initially, individuals may be assigned multiple roles; but as the SMC scope and capabilities expand, the roles may be more narrowly defined and assigned to single individuals.

Formalize External Interactions

Prior to officially starting the SMC capability, the principal external interactions should be formalized, along with the establishment of clear and coordinated lines of communication. It is important to formalize external interactions in order to reduce errors and omissions resulting from miscommunication and misunderstanding. This also helps in controlling cross-SMF request volumes and makes responses more predictable.

Outbound Interactions

The following outbound interactions summarize the handoffs or requests from SMC to other teams.
Supporting Quadrant—Incident Management. Whether an alert has been ticketed or if automated control steps have been performed, anything escalated beyond the SMC Control process should be forwarded to incident management. These situations typically require human intervention to appropriately diagnose and correct the situation.
Optimizing Quadrant. The Availability Management, Capacity Management, Business Continuity, Financial Management, and Workforce Management SMFs may be requested to provide details on service level breach analysis and metric calculation.
Operating Quadrant. Infrastructure management duties within the Operating Quadrant are related and commonly interdependent. SMC may give direct visibility to events and alerts to Operating Quadrant roles such as those in the Security Administration SMF.
Software Development and Application Teams. These teams may be asked to provide input specifically when SMC creates rules based on instrumentation and application behaviors. In turn, SMC may also participate at various points in the application life cycle in order to improve the application's manageability in production.
   Inbound Interactions

The following inbound interactions summarize the handoffs or requests from other teams to SMC.
Optimizing Quadrant. SMFs such as such as Availability Management and Capacity Management typically do not receive real-time SMC alerts. However, to effectively perform their regular availability and capacity management monitoring duties, they will require reports that are generated from SMC's event and alert data. It is important to note that SMC is not responsible for generating reports and the underlying analysis. SMC will only make the data available for these teams to use.

SMC tools may have the capabilities to generate canned reports and, if deemed necessary, specific requirements for this reporting may be included in the Prepare SMC Tools: Formalize Tool Requirements and Selection Criteria activity.
Change Management and Release Management SMFs. The request for monitoring a new or changed infrastructure will be generated from change management. The actual implementation and deployment of the infrastructure is handled in release management.

Updates to an SLA and the service catalog will generate notification from change and release management. SMC should be involved in the CAB when there is significant impact to monitoring.
Security Administration SMF. This SMF may request historical event data that will be used for forensics and security audits. Security administration may also need to take advantage of the real-time monitoring capabilities of SMC during security breach and emergency conditions.
Incident Management, Problem Management, Change Management, and Release Management SMFs. The request to suspend or restart monitoring may be generated from these SMFs. For example, a request to suspend monitoring may be put in place for the maintenance window of an application in order for it to receive scheduled maintenance. Similarly, a request for monitoring restart may be generated from problem management after a component failure has been corrected.

Adopt SMC Process

When formally adopting the SMC process for an organization, consider the fact that MOF is a framework as opposed to a strict methodology. This means it is adaptable and can be modeled to accommodate company and even organization-level specific needs. MOF's integrity as a best practice descriptive guidance is maintained as long as core elements are preserved; terms, their scope, and definitions are unchanged; and pre-established measurement for maturity is used. Any deviation from the base SMC MOF model should enhance the function, not complicate it. Adoption tuning may be used to address geographic distribution and industry-specific legislative requirements.

When initiating the SMC SMF processes, ensure that process controls and the KPIs are established for monitoring the performance of the SMC process itself. See Appendix B, “Key Performance Indicators,” for more details.

Prepare SMC Tools

The Prepare SMC Tools process flow activity focuses on key activities that should be executed in order to establish effective SMC technology and automation. Tools and technology are important to the SMC SMF since they enable repeatable, real-time observation, processing of events, and automated response.

Formalize Tool Requirements

There are many factors to take into consideration when selecting the principal tool used for SMC. Information collected and analyzed in the Establish: Prepare SMC Data process flow activity should be incorporated to build specific selection criteria. Other SMF teams should be involved in defining these requirements, along with input from software development and application teams. SMC tool requirements must be concrete and ideally contain measurable objective criteria.

The following list of considerations may be used in developing SMC tool requirements and selection criteria:
Performance. SMC tool requirements should address the needs for appropriate levels of performance to ensure low alert latency.
High-Availability Options. SMC tool requirements should address the needs for high-availability options such as clustering, failover, and synchronization for failover.
Tool Architecture. SMC tool requirements should address the needs for appropriate tools architecture so that the data sources and protocols are supported, the method of collection and threshold calculation as specified in an SLA's SLO and metrics can be applied, and have robustness for anomalies like a spike in network latency.
Event Routing and Forwarding. In organizations that have a geographically distributed SMC capability or have multiple consumers of console data, then the SMC tool requirements should address the needs for effective event routing and forwarding.
Autodiscovery. SMC tool requirements should address the needs for automatically discovering new managed nodes, infrastructure change, and monitoring targets.
Deployment. SMC tool requirements should address the needs for simple yet effective rules and agent deployment.
Network Adaptability. SMC tool requirements should address the needs for network adaptability in order to facilitate complex network topologies, routing protocols, and security segmentation.
Lightweight. SMC tool requirements should address the needs for a lightweight monitoring agent in order to minimize the impact of SMC on the infrastructure being monitored.
Scalability. SMC tool requirements should address the needs for scalability, such as the number of managed objects per server and the number of simultaneous events it can process at a given time. At a minimum, the tool must be able to address short-term infrastructure growth and conditions.
Interoperability. SMC tool requirements should address the needs for interoperability, such as integration with other management tools, and such processes as trouble ticketing
Reporting. SMC tool requirements should address the needs for reporting and offline data storage.
Data Repository. SMC tool requirements should address the needs for knowledge base and/or SMC data repository facilities.
Vendor Background. SMC tool requirements should address the needs for stable vendor support and that a commitment is present to correct tool issues through updates and patches.
Security. SMC tool requirements should address the needs for security, such as granular levels of access and role-based authorization, and safe alert transport and storage.
Pricing. SMC tool requirements should address the needs for pricing with evaluation of the overall total cost of ownership (TCO).
Dependencies. SMC tool requirements should address specific infrastructure and configuration dependencies for the tool itself. This is a very important and often overlooked consideration.

Here are examples of dependencies based on directory services:
Most organizations want to lock their directory services schema. A conflict may be caused if the SMC tool needs to extend this schema in order to add its own attributes.
If organizations do not have directory services and the SMC tool needs this for authentication or deployment, then the tool will not work correctly.

Design Management and Tools Architecture

Using a combination of all the knowledge that has been compiled through the Establish process flow activities, an initial management architecture should be created. This architecture is manifested typically in large graphical representations with supporting detail in separate documentation.

This architecture should include all core decisions on the following key areas:
Physical Infrastructure. Geographic and physical layout, failover, and clustering.
Network Topology. Network paths and logical routes.
Event Flow. Event format, flow, and forwarding.
Storage. Accessible data for reporting.
Console and Workflow. User and role interaction.
Security. Access control and secure transport and verification.

Initialize SMC Tools

Actual implementation of tools should follow the MSF life cycle. This implementation process should include the initial deployment of the tool in an isolated lab, then the pilot environment where it is iteratively improved, and then the release into production.

A typical implementation will involve the following activities:
Install operational database and SMC tool servers and application.
Develop monitoring rules for identified targets.
Develop monitoring and control scripts for identified targets.
Deploy agents.
Deploy rules and scripts.
Test and validate.
Optimize.

Noise Reduction

A process should be adopted to reduce the initial noise levels, which are caused by a barrage of alerts in the SMC tool. Keep in mind that there may be a barrage of legitimate alerts once a more effective monitoring process and toolset is in place. Issues that were previously undiscovered may surface and should be addressed with problem management. Noise reduction is an iterative process that includes the following high-level activities:
Initial review of Health Model, Health Specifications, and SMC tool rules. The SMC team as well as relevant subject matter experts review the detailed material and compile potential areas of improvement to be shared with the software development or application teams.
Isolated lab testing. After the Health Model and Health Specifications have been translated into a collection of rules, this material, any companion data collectors, and control scripts are checked to make sure that they do not introduce any adverse performance impacts to the SMC tool or managed node. Performance impacts can be caused by issues such as memory leaks and stale processes. During this test pass, the following performance counters are recorded:
   Process
   Processor
   Disk
   Network
Pre-production testing. Once the rules, companion data collectors, and control scripts have been checked in the isolated environment, they should then be promoted into a pre-production test environment where actual daily activities are performed on the infrastructure. An example of a pre-production environment can include a limited deployment to a pilot set or, where possible, carefully coordinated production systems that send events to both the production SMC tool and to a test SMC tool configuration. All the alerts generated in this testing should be forwarded to a common location, such as an e-mail distribution group, and subject matter experts can then subscribe to this alias. The alerts are then triaged and further diagnosis is made to reduce the alert count.
Reduction of alert volumes. Reduction of monitored events and alert volumes should be performed through a filtering and evaluation of validity and actionability:
Validity. Assessment of an alert to make sure that it indicates the actual problem that was experienced. An alert is valid if it accurately reports the state of the component, its functionality, and/or overall service. Invalid alerts are those that inaccurately report information.
Actionability. Assessment of the completeness of the alert's information in order to perform corrective action. Key attributes of the alert should be clear, unique, and may also be supplemented with a knowledge base article. An alert is actionable if the alert text and related information provide clear steps to resolve the issue.

The effectiveness of this reduction and additional suppression can be best measured using the Alert to Ticket ratio.
1 to 1. For every alert that is generated by the processing rule, it is estimated that one ticket will also be created. This is the goal and most ideal situation.
2 to 1. For every two alerts generated by the processing rule, it is estimated that one ticket will also be created. A ratio of less than 2 to 1 is often used as a target for highly mature SMC implementations.
Multiple to 1. This is usually considered beyond acceptable limits. Alerting should be disabled or better suppression and correlation should be implemented. However, there may be unique instances where this is unavoidable such as an unresolved recurrent critical issue. For these unique situations, the alert should be kept for further analysis.

Assess

Overview

Assess is the second major process in SMC and is responsible for the review and analysis of current conditions in order to make necessary adjustments to any aspect of the SMC function. Assess is similar to the Establish process' initial analysis because of the front-end holistic review that takes place in both. It differs because the goal of Establish's analysis is for implementing the foundational components of SMC, while Assess is concerned about the ongoing analysis for change and optimization within the run-time process group.

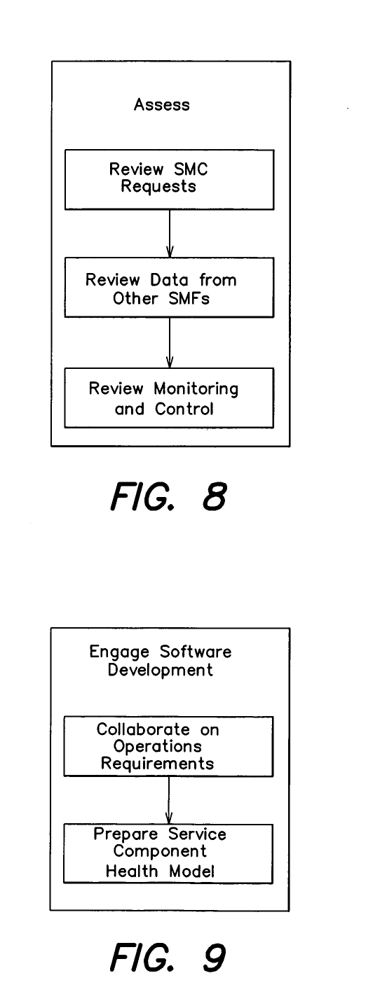

The approach to executing the Assess process flow is holistic. Although listed as a sequence, it should be seen as a global, or centralized, evaluation. FIG. 8 illustrates main activities of the assess process of one embodiment.

Assess should be performed when a new service component is introduced; when there is a change to the infrastructure, CIs, SLA, or service catalog; after specific Control actions have occurred, and at a predefined interval to review monitoring.

It is important to continuously assess in order to understand the impacts of different variables and to develop the necessary strategies that will be implemented in the Implement process.

Formal tests and validation activities within the run-time process can also be conducted as needed in the Assess process.

The activities in assess should use all available automation—for example, autodiscovery, tools, and scripted procedures.

Assess Process Activities

Review SMC Requests

For the Review SMC Requests activities, all analysis is performed in the Assess process and execution or actions are performed in the Implement process.

Examples of SMC requests include:
Suspend Monitoring. This request is typically generated for the temporary suppression of alerts for a given timeframe. The Problem Management, Change Management, and Release Management SMFs typically generate this request, as well as special cases and conditions as defined in the SLA.

Patch management operations may also request a suspension of monitoring during the patching process.
Restart Monitoring. This request is typically generated when problems are identified that are related to the SMC agent or are affecting the system. Other situations include patches that have been applied to the system, which requires rebooting, or the monitoring agent must be rebooted or refreshed. Restart monitoring requests are generated from problem management, change and release management, as well as special cases and conditions defined in the SLA.
Start Monitoring (New/Change). The start monitoring request is generated from the Change Management and Release Management SMFs. This involves defining a Health Specification or Health Model and implementing the agent, rules, scripts, and configuration. The analysis portion of this request, specifically the Health Specification or Health Model as well as configuration parameters, is performed in the Assess process. All other deployment and implementation specifics are handled in the Implement process. These activities should be managed though the MSF life cycle as part of normal application deployment.
Change Monitoring Parameters. The change monitoring parameters request is generated from teams in IT operations and passes through change management for routine changes or through problem management during a break/fix situation. Key parameters involved in monitoring changes include:
   Providers
   Responses
   Thresholds
   Frequency (Suppression)
   Rule Attribute (such as Rule Name)
Examples of change monitoring parameters requests include:
   Threshold Change. Changing a specific threshold that determines when alerts are triggered.
   Frequency Change. Changing the sampling interval that the SMC tool polls the CI.
   Rule Change. Changes to individual rule sets that define the processing of an event. This could also include the optimization in changing the processing categories such as consolidate to filter and filter to collection.
Removal of Monitoring. The removal of a monitoring request is generated from many teams in IT operations and passes through change management. This request is typically associated with the decommissioning of infrastructure components.

Review Data from Other SMFs

Artifacts from other SMFs may have a direct impact on SMC. Although changes to key documents are promoted through change and release management, internal SMF processes may not be subject to change and release management on the basis of impact and policy. The SMC Assess process should continuously evaluate the following SMF data:
SLA and Service Catalog. Changes to the SLA have significant importance to SMC in relation to monitoring scope and inclusion (determining whether a service should be monitored) and service components (determining the infrastructure that should be monitored and at what level).
Capacity and Workforce Plans. Changes to these plans may impact SMC's ability to deliver its services. SMC should have adequate resource capacity, including staffing.

The Assess process should also check the reporting and data volumes, especially if other SMFs are running as-needed reports and affecting the SMC tools. Teams who are customers of SMC data should not perform any reporting function using the SMC tool operational database. These customers should use external data sources provided by SMC so that they do not adversely impact the production systems.

It is important to remember that SMC does not create reports; this is the responsibility of other SMFs. For example, SMC is not responsible for the creation of an availability report. This is explicitly the role of the Availability Management SMF, although SMC may provide the empirical data used for this availability report. The SMC tool may have reporting capability; however, this functionality may be assigned to the respective team that has responsibility for it.
Operating Quadrant Conditions. Any changes to the data managed by these SMFs in the Operating Quadrant may directly impact SMC.
   Security Administration SMF. Changes in security policy, access control, authentication, and authorization may require changes to the architecture of SMC tools. For example, when a Control procedure is executed, it typically runs under predefined user and group contexts. If there are any changes to this user and group, it may cause the procedure to fail; or worse, it may execute in unpredictable ways.
   Directory Services Administration SMF. Changes in directory services may require changes to the architecture of SMC tools. For example, if the SMC tool relies on the directory to store and deploy configuration data, changes to the directory's schema and reference model may disable tool capabilities.
   Network Administration SMF. Changes in the network may require changes to the architecture of SMC tools. For example, if new routes are added to the network that changes the path of SMC messages, saturation of that segment can cause SMC tools to be unable to receive their important alerts.

Review Monitoring and Control

Conditions of SMC-specific components should also be reviewed and assessed. This is important in order to deliver the agreed-upon levels of monitoring and control capability as well as support to the other SMFs that rely heavily on SMC services. The following activities describe the review of various SMC-specific components.

Assess SMC Tool Components
Agent Condition. The agent collects service component events and performs preliminary filtering and, if defined within rules, raises an alert that is sent to the SMC tool server. The agent also facilitates the execution of Control procedures on the managed node. Consistent operation of the agent is critical to SMC and should be checked frequently. Make sure that the agent is providing accurate polled checking (also called a heart beat) and that it is operational and functioning normally.
Server Condition. The server is a core processor of events and alerts and performs deeper correlation prior to creating notification using e-mail or page, or through the console. The server should be assessed for proper operation to make sure that no serious faults have occurred and that all tool subsystems are functioning normally. Also check to make sure that the server is receiving data from agents. If no alerts are being received, it indicates that either the environment and all the services are in perfect condition (no faults) or, more commonly, that there is a failure in the SMC tool.
Database and Reporting Condition. The tool database is the repository of events and alerts and their metadata, such as receipt time, source, and state. The database and its associated SMC tool reporting functions should be checked frequently to make sure that all subsystems are functioning normally, data has not been corrupted, cascading errors have not been transmitted to different areas, and necessary resources are available such as tablespaces.

Review SMC Analysis Schedule

The frequency of scheduled optimization analysis should decrease over time. This schedule for periodically assessing the monitoring of a specific service decreases because SMC will become more stable and increase in its optimization and ability to reuse its process artifacts.

Analyze Monitoring and Response Rules

The rules implemented in the SMC tool should be continuously evaluated for optimization. Ideally, alerts that are presented to operators are a true indication of a service issue and map directly to a specific actionable response. All other alerts have either been suppressed, removed from SMC, or automatically resolved using Control mechanisms.
Generate SMC Reports. Reports should be generated on SMC indicators on a regular basis. The frequency for performing this is determined by the analysis schedule.
Analyze SMC Statistics. The following statistics should be reviewed to understand the performance of SMC as well as to identify opportunities for improvement. Each value is mapped over predefined timeframes (such as daily/weekly/monthly).
   Number of Alerts Generated. As the Health Specification or Health Models are refined and rules are optimized, the mean of this count should significantly reduce.
   Top 10 Alerts by System. This count should be reviewed to determine the alerts and events that should be evaluated for optimization.

This statistic should also be analyzed to see if certain problems recur and may be chronic. This information should be given to problem management and if the solution is consistent each time, an automated Control response may be developed.
Alert to Ticket Ratio. This is a key statistic that indicates the quality of SMC alerts. The goal is to achieve a 1:1 ratio between alerts and tickets. This indicates that each alert is valid and has a well-defined and well-documented problem set associated with it.
Mean Time to Detection (such as Alert Latency). This statistic should dramatically improve with the implementation of effective SMC tools. Alert latency is the measurement of the delay from when a condition occurs to when an alert is raised. Ideally, this value is as low as possible.
Number of Tickets with No Alerts. A high count of tickets with no alerts is an indication that monitoring missed critical events. This statistic can be used as a starting point for improving instrumentation and rules.
Number of Events per Alert. As rules and correlation improve, this count should increase. Often, multiple events are triggered; however, there is typically only one true source of issue. A high events per alert count may also indicate opportunities for reducing the number of exposed events.
Number of Invalid Alerts. Alerts that are generated with incorrect fault determination should be carefully reviewed and corrected. The number of invalid alerts may increase during the initial deployment of new infrastructure components and services; however, it should drastically decrease with better rules and event filtering.
Mean Time to Repair. This statistic is typically used in capacity and availability management; however, SMC should analyze problems that were corrected using SMC's Control. This metric measures the effectiveness of the automated response from this process. This value should decrease as more situations are handled by SMC automation.

Obtain Feedback from Monitoring Consumers

On a weekly or biweekly basis, interview SMC data consumers (console operators, recipients of auto tickets, and other notified parties) for anecdotal information. The objective of this activity is to capture opportunities to improve the quality of SMC work products through observed behaviors that may not necessarily be reviewed through formalized metrics.

Engage Software Development

Overview

The purpose of the Engage Software Development process workflow activities is to give operational guidance to internal software development and application teams for creating applications that are more operations-ready and monitoring-friendly. This guidance will improve the overall availability and reliability of their applications. FIG. 7 illustrates the main activities of the Engage Software Development process.

Engage Software Development Process Activities

The following sections provide further details about each of the activities in the Engage Software Development process.

Collaborate on Operations Requirements

Infuse SMC Findings for Application Improvement

SMC should provide feedback to internal software development and application teams in order to improve overall manageability, especially with the current version of the application in production so as to influence subsequent versions that are being developed.

This activity includes the following key communications:
Validity of Instrumentation. Provide feedback on the validity of events, with the potential to remove those that refer to conditions that do not truly exist.
Reliability and Consistency of Instrumentation. Provide feedback on the reliability and consistency of the instrumentation for potential correction and improvement.
Actionability of Instrumentation. Provide feedback on the actionability of instrumentation, specifically the use of name and description fields, as well as making sure to retain the unique ID numbering processes, and minimize use of overloaded attribute values.
Completeness and Accuracy of Instrumentation. Provide feedback on the completeness of information contained in the alerts and events, as well as the accuracy and compliance to taxonomy standards.
Initial Prioritization. Provide feedback on the initial prioritization of instrumentation.

For example, the software development team may have considered a specific event to have a priority level of High; however, in production with relative weighting with all other applications, it should actually be Low.
Instrumentation Behavior. Provide feedback on the frequency and exposure protocol or method used. The instrumentation may be triggering too often and causing too many events for the same condition. The instrumentation may be using an older protocol specification when a newer and more secure version and API are available.
Synthetic Transaction Capability. Software development may be able to improve or expose probes that can be used to perform synthetic transactions, which test internal business logic through a simulated transaction.
Preliminary Diagnosis and Self Correction. The goal for software development in relation to IT operations is to develop applications that are aware of their own issues and self correct them. SMC can provide consultative guidance-based operations experience to help applications mature in this direction. For example, strategies used in the Monitor and Control processes may be implemented internally into the application.

For more information on topics concerning management instrumentation for software development projects, please refer to Enterprise Instrumentation Frameworkfor .NET at http://msdn.microsoft.com/vstudio/productinfo/enterprise/eif/

Include SMC Requirements in Release Package Requirements in release management should be added to address the needs of SMC. This may include:
Delivery specifications (Health Model and instrumentation specifications)
Probes and interfaces for Control
   Command line
   Remotely accessible (accessible using WMI, for example)

Prepare Service Component Health Model

Development and application teams should be required to deliver their software packaged with its associated Health Model. A Health Model (also called a Health Specification for COTS) documents significant information for monitoring a application. This may include all actionable events, event exposure and behavior, and instrumentation protocols and behavior. Ideally, this information is directly codified into a language or configuration dataset that may be used by SMC tools. It is important to define taxonomy standards prior to documenting a Health Model so that the specific attribute values related to classification and prioritization levels align to a common reference.

There are two types of Health Models:
Class-level. Creates specifications based on a class of common infrastructure or service components. In a large organization with significant online presence using similar hardware and applications, an example may be a Health Specification for Web servers.
Override-level. Creates specifications based on individual infrastructure or service components that fall outside of a class grouping. In a large organization consisting mostly of databases using Microsoft SQL Server, an example may be a Health Specification for a specific host running Microsoft Access.

Reasons Why a Health Model Is Needed

Not knowing the information contained in the Health Model contributes to the following issues:
Administrators do not know when things are going wrong until something breaks.
When something breaks, it is difficult to determine what is broken and what to do about it.
Automatic monitoring tools do not have sufficient knowledge about the system to repair the problem.
Product support does not have the information required to troubleshoot the application.

The Health Model addresses the above problems by:
Prioritizing an application's top known support and customer issues.
Documenting all management instrumentation that an application contains that can be used to determine health.
Documenting all known health states and transitions that the application can potentially go through during its life cycle.
Documenting the detection, verification, diagnosis, and recovery steps for all “bad” health states.
Identifying instrumentation (events, traces, and performance counters) necessary to detect, verify, diagnose, and recover from bad health states.
Refining the model as new states, transitions, and diagnostic steps are identified through customer, support, test, and community inputs.

General Guidelines for Creating a Health Model

The following is a list of best practices that can be used when creating a Health Model.
Define events with proper severity, so do not mark an event as an error unless it actually requires someone to take action and fix the condition.
Define events with unique ID and source combinations. Do not overload an event ID, which can cause monitoring tools to parse the event description to find the ID.
Do not generate events too frequently.
Define event descriptions accurately and, as much as possible, make the description actionable.
Do not expose performance data through events.
When appropriate, expose well-defined interfaces.
Measure availability or performance: generate events or alerts when defined criteria exist or thresholds are exceeded.
Determine the next steps to be taken: management rule sets can take advantage of scripts and state variables on the managed nodes to diagnose further.
Use simple measurements: CPU/memory usage, Windows Events, ability to read or write to a file or API, and service status results, for example.
Allow threshold modification: The Health Model must be able to customize to fit customers' IT policies for infrastructure health.

Steps in Building a Health Model

Building the Health Model requires the following steps:
1. Obtain a thorough understanding of application behavior and internal condition triggering.
2. Enumerate all management instrumentation the application exposes. This will help identify additional health states and transitions, align instrumentation with the model, and identify where additional instrumentation is necessary.
3. Analyze instrumentation and document health states, detection signatures, verification steps, diagnostic steps, and recovery actions.
4. Analyze the service architecture for potential failure modes not currently exposed by instrumentation.
5. Add all states that can only be detected by inspecting instrumentation or by exercising instrumentation methods.
6. Create models that show health states and transitions between them.
7. As the code evolves, update the model to accurately reflect the code. Add new health states and events to the model, and make sure that required instrumentation is in place.
8. Use feedback from SMC and other SMFs to discover unknown problem states, and update the model accordingly. Add instrumentation where required to support these new states.

The following example gives a thorough description of the steps used in building a Health Model.

Steps 1 and 2. Obtain a thorough understanding of application specifics and management instrumentation exposure.

This can be accomplished by SMC collaborating with the application and development teams.

Step 3. Analyze instrumentation and document health states.

Using the SMC data repository, identify application events, and populate information for each key event.

Examples of data that may be collected is shown in Table 4 below.

TABLE 4

| Item | Description |
|---|---|
| Event ID | Event ID as reported to log |
| Symbolic name | Symbolic name for the event. |
| Facility | [Optional] Facility for the event. |
| Category | [Optional] Category for the event. |
| Type | Event type as reported to the event log. |
| Level | Severity of event. Revise if necessary. These might include: |
| | Critical: The application has encountered a critical degradation in its |
| | health or capabilities, which prevents it from servicing any subsequent |
| | operations. |
| | Error: The application has encountered a partial degradation in its |
| | capabilities, but it may be able to continue to service further requests. |
| | Warning: The application has encountered problems that are not |
| | immediately significant but which may indicate conditions that could |
| | cause future problems. Also, the application has detected problems in |
| | a different application. (However, these problems do not affect the |
| | application's health or capabilities.) |
| | Informational: The application has encountered a positive change in |
| | its capabilities (that is, recovered from a previous degradation). These |
| | often negate previous degradations. |
| | Verbose: Diagnostic trace signifying detailed information from |
| | intermediate steps taken by the application while executing. |
| Message description | Event message description as written to log. |
| | Review and update as needed. Admin Event messages must have: |
| | Explanation: The explanation should provide a text description of |
| | what occurred and the change in the capabilities of the service that |
| | resulted from it. If the change is negative (that is, a degradation in |
| | capabilities), this description should specify the degradation that |
| | occurred. If the change is positive, this description should state what |
| | the new or restored capabilities are. |
| | User Action/Remedy: (not applicable for informational events): The |
| | user action/remedy presents steps the user can take to fix the problem, |
| | to diagnose it further, or both. It could include running a utility or |
| | performing a different task to fix the problem, retrying an operation, or |
| | looking into another log for further information about the problem. |
| Tag | This column should show into which classifications the event falls. |
| | Tags for event types that are specific to the service can also be added. |
| | Install: The event indicates the installation or un-installation of an |
| | application or service within the service raising the event. |
| | Settings: The event indicates a settings (configuration) change in the |
| | service. |
| | Life cycle: The event indicates a run-time life cycle change (for |
| | example, start, stop, pause, or maintenance) in the service. |
| | Security: The event indicates a change that is security related. |
| | Backup: The event indicates a change that is related to backup |
| | operations. |
| | Restore: The event indicates a change that is related to restore |
| | operations. |
| | Connectivity: The event indicates a change that is related to network |
| | connectivity issues. |
| | Low Resource: This event is related or caused by low resource (for |
| | example, disk or memory) issues. |
| | Archive: This event should be archived for the purpose of availability |
| | analysis. (These events must be infrequent-for example, restarting |
| | the computer.) |
| Insert parameters | Enter real property names for each of the insert parameters for this |
| | event. Use commas to separate insert parameters. |
| Blame component | If the blame for this failure falls on one of the dependencies, state the |
| | dependency to blame for the failure. |
| State before | Operational state of the application or service before the event. |
| State after | Operational state of the application or service after the event. |
| Desired state | Operational state in which the application or service would have been, |
| | had the event not occurred. |
| Event group | Name of a group of related events, all signifying a transition from one |
| | health state to another. Use a separate name for each transition line, |
| | but give the same name to all events that indicate that particular |
| | transition. |
| Availability | Current level of service availability in this state. Availability can be: |
| | Red: No service/functionality is available. |
| | Yellow: Partial service/functionality is available. |
| | Green: All service/functionality is available. |
| Verification | Test, probe, or presence/lack of an informational event that can be |
| | used to verify whether the service is in the detected state. |
| Diagnosis | What should be inspected to determine the root cause of why the |
| | application is in this state? |
| | Diagnosis typically starts by enumerating the list of “Detection” events |
| | and identifying where diagnosis should start for each one. |
| | Events, traces, configuration settings, WMI providers, and |
| | performance counters can all be sources for diagnostic information. |
| Recovery | How can the application recover from this state? What actions should |
| | be taken? |
| | Configuration settings, WMI providers, troubleshooters, and |
| | monitoring rules can all be used as potential recovery steps. |
| Auto-retry | Does the application automatically attempt to recover from this state? |
| | If so, how often? |
| Anti-event | Event that indicates a possible return to a healthy state for this event. |
| | If verified, invalidates the original transition to a bad health state. |
| Comments | General comments around this event, this state, or both. |
| Source file | Convenience column for listing the source file from which this event |
| | is logged. (Note: This is optional but has proven useful for some teams |
| | doing their analysis.) |
| Probability | Probability of occurrence of this event based on knowledge of the |
| | code path and experience from previous support issues. This is fairly |
| | subjective and is meant to help prioritize which events are most |
| | important to work on. This field can have a value of: |
| | Rare |
| | Low |
| | Medium |
| | High |

Step 4. Analyze the service architecture for potential failure modes.

Map both the internal and external dependencies and how they can fail.
Examine the code for locations where failures are encountered, recovery logic has been written, or both.
Ensure that each of these locations in the code exposes the proper type of instrumentation based on the instrumentation selection guidelines provided later in this document. The instrumentation must provide the administrator or user with clear information about actions to take, the cause of the problem, the loss in functionality, and further diagnostic direction.
Make sure to have instrumentation to signal transitions from bad states to good (anti-alerts).
Update the instrumentation and state diagrams with this information.

Step 5. Add states that can be detected only by exercising instrumentation.

Not all health state transitions can be detected, diagnosed, and verified from inside of the service itself. For this reason, it is also important to document which client applications or services rely on the services, how they might be exercised to test the health of the service, and how the management instrumentation that they expose could indicate the failure to supply proper service to them.

An application might, for example, publish the average transaction time over a certain interval as a performance counter. An external service can detect a performance degradation by comparing this to historical data and generate an appropriate event. An application might also be blocked by waiting for an external application that has stopped responding.

Step 6. Create the health state diagrams.

A visual representation helps illustrate how the application or service looks as a whole.

A visual health state transition diagram also can pinpoint where instrumentation is missing.
9. Create a diagram that shows the states and the signals of transitions between those states (event groups)
10. Look for locations where there are clear transition/recovery paths that no instrumentation will detect.
11. Add the proper instrumentation to the code to be able to detect these conditions, and update the spreadsheet and diagram accordingly.
12. Add events or other instrumentation to signal transitions from bad states to good.

Step 7. Incorporate code changes.

The code base is always evolving. New code is introduced, and old code is refactored.

As the code evolves, keep the model up-to-date with the new code. These modeling documents need to be treated as living specifications that must be kept in synchronization with the current architecture at all times.

Step 8. Incorporate customer feedback.

Customers, community, product support, and test resources will report problems and solutions over the life cycle of the application.

New health states will be identified, alternate verification and diagnostic steps will be found, and quicker recovery paths will be discovered as services are deployed and used. The Health Model is a living set of documents. It must be improved over time as customers communicate how they manage the services in their environments and identify where management instrumentation needs to be added to future releases.

Implement

Overview

Implement is a major process in SMC that is responsible for the implementation of decisions made from the analysis in the Assess process. Implement is part of the run-time function of SMC.

The Implement set of activities is performed after Assess has qualified and analyzed a particular need and has designed a solution. The Implement activities are executed by SMC's internal staff in coordination with other SMFs, especially those in the Operating Quadrant. As appropriate, change and release management are largely responsible for controlling the alteration of tools and infrastructure.

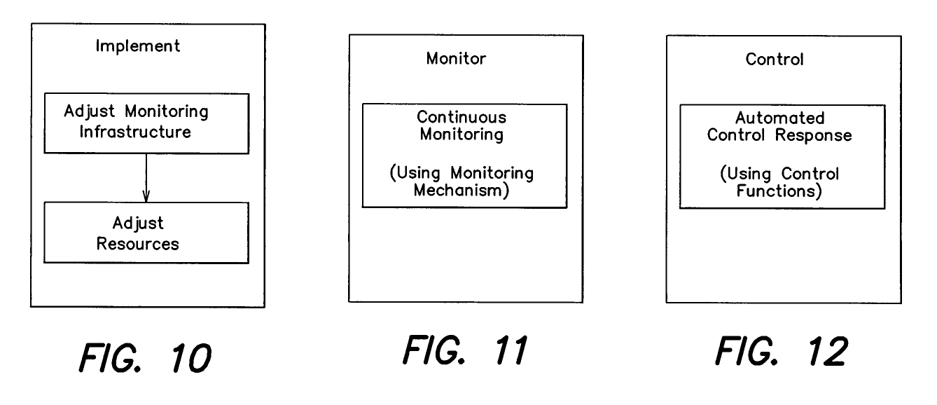

The activities in the Implement process flow should take advantage of all available automation, such as autodiscovery, tools, and scripts. FIG. 10 illustrates main activities of the Implement process.

Implement Process Activities

The following sections provide further details about each of the activities in the Implement process.

Adjust Monitoring Infrastructure

Implement Monitoring for New Service Components

Implementing monitoring for new systems and applications flows through the Assess: Review SMC Requests activity to analyze the monitoring target's needs. It is important to consider the impact of the Domain, Security, and Network models during this implementation. The Security and Domain models will dictate the user context in which the SMC tool performs its work. If the user/group using the SMC tool does not have adequate privileges, then the SMC tool will be unable to probe health conditions on the target. Control scripts may fail or partially execute from lack of adequate permissions. The Network Model dictates the access of monitoring traffic to the SMC tool server. If certain ports are blocked or if specific networks are segmented such as in a perimeter network (also known as a DMZ), then health status cannot be communicated and notification will fail.

Adjust Monitoring Parameters

Adjust Thresholds

A threshold is the tolerable limit of a metric before an alert is generated. This limit is defined in the SLA, usually by availability, continuity, or capacity management. Any adjustments of thresholds should first be analyzed through the Assess process. Threshold adjustment should also be coordinated by change management as appropriate. When adjusting thresholds, make sure the new values are within the operating parameters of the element. Also make sure that thresholds match definitions from the Health Specification or Health Model.

Adjust Alert Prioritization

Changes to alert prioritization should be made with caution since certain changes may make an alert too visible (the notification may be inadvertently distributed to higher-level personnel) or hide the alert (the notification may be undetected and unresolved). Changes to alert prioritization should be performed after Assess has reviewed and optimized the alert's validity and actionability. (See Validity and Actionability for more details)

Adjust Rules

Changes to rules should also be made with caution due to the potential for causing a flood of events or even damage through the misapplication of automated Control procedures. Following is a list of general guidelines for identifying the proper rule type to which changes should be applied:
Collection Rules. Use collection rules only when you want to use the event for trending and analysis. This should not be used for actionable events.
Filtering Rules. Use filtering rules when you want to filter or squelch an event, such as noise or unnecessary informational. You can also turn off filtering for debugging purposes.
Consolidation Rules. Use consolidation rules when the specific event that needs to be alerted is very important, but the nature or frequency of that event is too high. During an improvement cycle, software development or application teams may be able to adjust instrumentation frequency for future releases.
Missing Event Rules. Use missing event rules if you want to be notified or alerted when an event that is supposed to regularly occur does not occur. An example of this is a constant heartbeat ping check.
Correlation Rules. Use correlation rules when multiple occurrences of an event or other instrumentation types have contributed to a common issue.
Frequency of Event/Instrumentation. Adjustment of the rules should be based on the collection from the last cycle.
Synthetic Transactions. Use synthetic transactions to provide a more accurate view of the application's end-to-end availability, based on an actual transaction that the application can perform.

Adjust Event Routing and Forwarding

Changes to event routing and forwarding should be based on changes to the organizational model of the company. Event routing and forwarding is typically performed in SMC tool implementations with a multitiered topology or with multiple single configurations needing wide alert visibility.

Develop and Implement Automated Response

Automated corrective response or control scripts can be developed after Assess has analyzed these opportunities for specific alerts. This automation should only be written against high-confidence conditions.

Automated response can take the form of one function or a combination of the following:
Active Response. Performs actual system changes in order to correct a fault condition. An example of this is shutting down and restarting a process.
Informational Response. Performs actions that are related to informational status only. An example of this is enabling debug-level logging when there is a detected security breach.
Monitoring Response. Performs actions that are monitoring- and instrumentation-specific. An example of this is closing an event or incrementing an external counter.
Integration Response. Performs actions that are beyond the standard SMC scope. An example of this is autoticket generation for incident management.

Develop or Update Knowledge Base and Document Event Behaviors

It is important to keep good documentation on all event and instrumentation behaviors, rules, and responses. Knowledge base articles may be used as a way to keep track of these changes and optimizations.

Event and instrumentation documentation should include updates to the Health Specification or Health Models and their troubleshooting steps.

Rules and response documentation should include design rationale, conditions for triggering, and expected outcomes.

Adjust Resources

As more infrastructure is monitored by SMC, there may be a need for increased staff to support the Assess and Monitor capabilities. Capacity and workforce management should coordinate any changes to staffing levels and resource allocations.

Monitor

Overview

The process of monitoring is concerned with the real-time observation of health conditions through technology-based notifications triggered by predefined thresholds and conditions. The Monitor process also documents the health state to ensure that adequate management information is available for maintaining agreed-to levels of service performance or, at a minimum, for quickly recovering service levels in the case of failure.

This process can also initiate a regular set of tasks (for example, daily/weekly/monthly) to record historical data for trending purposes. This data is normally used by other SMFs within the MOF Optimizing Quadrant (such as Availability Management and Capacity Management) and also to aid staff investigating underlying problems as part of the problem management function.

Monitor is performed by a monitoring operator role, typically in a Network Operations Center (NOC) or within the service desk. FIG. 11 illustrates a main activity of the Monitor process.

Monitor Process Activity

Monitoring Mechanism

Monitoring can be performed using multiple views into the SMC tool. The two most commonly used notification media are through a dynamic console or through a notification device using e-mail or short messaging.
Console Notification. SMC tools can show the health state of services and service components through a console such as in a centralized organization with 7×24 operations. This is the most common means of achieving SMC visibility over a large infrastructure.
   Alert-based. For ease of use, consoles can provide an iconic view such as showing a red, yellow, or green flag to indicate alert priority and status.
   Pattern-based. Consoles can also represent data in graphical format such as a line graph. This facilitates signature-based pattern recognition, which is performed by senior SMC operators or SMC engineering staff.
E-mail or Short Messaging Notification. SMC tools can show the health state of services and service components through e-mail and short messaging typically sent to a pager, PDA, or cell phone. This is different from an incident or problem management dispatch in that the objective here is to communicate service and service component health, not necessarily a failure condition that must be acted upon.

Control

Overview

Many of the conditions observed in the Monitor process may represent incidents that can be automatically corrected in order to maintain or recover a service or a service component that may be affecting the business operations.

In order to minimize the impact of such incidents on business operations, the Control process deals with taking appropriate remedial actions to maintain or recover the affected services or their components. Actions referred to here are all performed in response to a message generated by one or more management tools. If an event creating a message represents an incident, most management systems can start actions to control, or correct, it. However, controlling actions are also used to perform daily tasks, such as starting an application every day on the same node. FIG. 12 illustrates a main activity of one embodiment of a Control process.

Automated Control Response

Automated actions do not require any operator intervention and usually start as soon as a message is received. An operator can manually restart or stop them if necessary.

Where automated actions are used, the start rule should be recorded in the monitoring tool. If the operation of the rule is successful, it should be similarly recorded in the tool and the incident closed.

The unsuccessful operation of an automated response should, however, invoke the incident management process in order to resolve the incident. In this instance, the incident record is required to record the start and unsuccessful operation of the rule. Manual actions then need to be carried out by the appropriate support specialists using the agreed-on incident management process.

When automated actions have been run successfully, the advice should be closed without reference to the incident management process. The data on these successes should be made available to any other SMFs that may require it for trending purposes, or to aid proactive activity within availability management, capacity management, and problem management.

Closure and Recording

When an incident record has been raised following the unsuccessful operation of an automated action, the alert needs to be closed in the monitoring tool and the incident record should also be updated and closed.

During the closure process, the incident record should be updated with any further resolution information that may be useful in the future if the incident recurs.

It may also be helpful to update any local knowledge base that is provided within the service monitoring and control tool itself with any appropriate information relating to the particular advice issued or remedial actions required. This will ensure that the knowledge base grows into a valuable management tool for the future.

Control Process Activity

Control Functions

To initiate Control, service monitoring and control must define a set of rules as a predetermined task or set of tasks that are to be followed when a specific event occurs. These rules can be a script, program, command, application start, or any other response that is required in reaction to the event.

If the rule specifies that remedial action is required, then this should take the form of either manual or automated tasks. The process followed for each option is different. Where manual actions are required, the incident management process should be invoked in order to open an incident record. This invocation can be automatically completed by the monitoring tool or may require the operator to initiate it directly or by using the service desk.

The following are the three types of control functions:

Diagnostic Control

All diagnostics should be performed automatically by the system. Any incidents that require operator-based diagnosis should be forwarded to incident management for proper handling.

Guidelines for Creating Diagnostic Control

The following best-practice guidelines should be considered when creating automated control capabilities.
Control programs should be timeout-based. This means the script or code developed should be able to receive signaling for timeout and/or have thread timers so the script does not run indefinitely.
Control programs that have long execution times should be asynchronous or nonblocking. This means that parent processes such as the SMC tool agent do not have to wait long periods of time until the process has been completed.
Control programs should use proper security credentials. Typically, these programs use credentials that are inherited from the parent or root process. It may be necessary to force alternative credentials within the process. Additionally, if the programs or scripts have to access external systems such as databases, they should have proper security credentials in order to connect and retrieve the data. This guideline reinforces the need for appropriate Security and Domain models.
Control programs should not expose passwords or sensitive information. Programs and scripts used in the Control process should not hard-code passwords and/or other sensitive information such as hidden LDAP attributes. Use domain user and group contexts as well as databases if necessary.
Control programs should have a process execution control loop. This means that the programs or scripts should give explicit feedback on the success or failure of the control. The control may use intrinsic objects to directly generate an alert in the SMC tool, or use extrinsic objects such as an exit code or executing another program, or through different instrumentation to make this feedback.
Control programs should be traceable (for example, through logging).
Control program requirements should be in place. This means any dependency downloads should have been made during the implementation of monitoring technology. Dependency downloads may include libraries, run-time executables such as Microsoft Visual Basic® Scripting Edition (VBScript), or messaging and probe capabilities such as WMI.
Increase Control capabilities through better application or service component development. The need for Control program interfaces should be communicated to the software development and application teams in order to improve probing and command-line tools that interrogate and correct specific conditions.

Interoperability Control

Rules for alert handoff to incident management should be formalized in the Establish process. Theses rules should include specific incident prequalification data and could possibly include all the information about the specific event and instrumentation, conditions, alert, and knowledge base information. The handoff should be seamless and controlled and should update traceable states either within the SMC tool or through logged notification.

In general, all alerts that need manual investigation or diagnosis should be handled by incident management. Special conditions that dictate the handoff should be directed toward the Problem Management SMF or Optimizing Quadrant SMFs (such as Availability Management) must be included in the service level agreements.

Two key types of interoperability control are autoticketing and mid-manager.

Autoticketing

One way to effectively handle this transition to incident management is through automatic ticket generation, also known as autoticketing. This advanced capability is performed by integrating the SMC tool with a Trouble Ticket (TT) system. The data from SMC must be mapped appropriately to the fields used by the TT system. Closure of the TT should close the SMC tool alert; and alternatively, a closure of the SMC tool alert should flag a resolution state in the TT.

Mid-Manager (Manager of Managers)

Another way to effectively handle transitions to and from other SMFs such as Network Administration is through manager tool integration. This advanced capability is performed by integrating other management systems with the SMC tool. The data to and from SMC must be mapped appropriately to the commonly understood fields. Closure of the alerts from either system should close the other. Acknowledgement of alert receipts should also change the alert status appropriately across all integrated systems. Issues that must be addressed include alert latency, integration and interoperability, and control coordination.

Notification Control

A control can be created for the sole purpose of notification of the appropriate process or personnel. This is typically performed to escalate a failure situation to the Service Desk or Incident Management SMFs. This automated response is similar to the Monitor process notification medium.

E-mail or Short Messaging Notification

SMC tools can notify in the Control process through e-mail and short messaging typically sent to a pager, PDA, or cell phone. To enable this capability, an organization may need additional supporting infrastructure including:
Effective e-mail system
Internal paging gateway
Connection with 2-way paging or messaging service bureau

Roles and Responsibilities

This chapter describes the roles and associated responsibilities of the Service Monitoring and Control SMF. It is important to note that these are roles, not job descriptions. A small organization may have one person perform several roles, while a large organization may have a team of people for each role. It is recommended, however, that one person perform the SMC service manager role.

Overview

Roles associated with the Service Monitoring and Control SMF are defined in the context of their functions and are not intended to correspond with organizational job titles.

Principal roles and their associated responsibilities for service monitoring and control have been defined according to industry best practice. Organizations might need to combine some roles, depending on organizational size, organizational structure, and the underlying service level agreements existing between the IT organization and the business it serves.

The roles also correspond to the roles defined within the seven role clusters of the MOF Team Model. These role clusters (Release, Infrastructure, Support, Operations, Partner, Service, and Security) represent at a high level the functions that must be performed in an IT environment for successful operations. The roles within each cluster are closely related to one another.

To execute the service monitoring and control process, the MOF Team Model identifies the role clusters associated with the SMF activities. This is described in Table 5 below.

TABLE 5

| Role Cluster | Involvement |
|---|---|
| Infrastructure | Provides technical expertise in all processes of service monitoring and |
| | control. This includes the deployment phase activities such as the initial |
| | review, product selection, and architecture. This also includes run-time |
| | phase activities such as the ongoing infrastructure assessment for tuning |
| | and optimization, and building a Health Specification and Health Model. |
| Operations | Offers advice and guidance on how service monitoring and control can |
| | be implemented and tuned without undermining day-to-day operations |
| | of the technology. Provides advice on training requirements for |
| | operations. |
| Partner | Provides input on how to accommodate third-party and supplier-related |
| | interactions including vendor selection, support of third party |
| | applications, and building health specifications. |
| Release | Manages the release of the service monitoring and control capability |
| | into production as outlined in the establish process. Provides ongoing |
| | management support for service monitoring-related configuration |
| | deployments. |
| Security | Provides advice on security issues related to the establishment of service |
| | monitoring capability including product selection and architecture. |
| | Offers guidance during ongoing assessment of service monitoring. |
| Support | Provides advice on process handoff to the service desk. Offers key data |
| | needed to map taxonomy standards between the service monitoring and |
| | control SMF and the incident management SMF. |
| Service | Offers advice on identifying appropriate service level agreements and |
| | the service catalog. Offers planning information associated with these |
| | two service level management SMF products. |

The five significant roles defined for the service monitoring and control management process are:
SMC requirements initiator
SMC service manager
SMC monitoring operator
SMC engineer/architect
SMC developer and tester

SMC Requirements Initiator

The SMC requirements initiator role can be carried out by anyone within an organization who needs to use the service monitoring and control SMF (for example, other SMF owners, business, customer, or third parties). The SMC requirements initiator has the following responsibilities:
Follows the documented process for submitting requirements.
Reviews and agrees on service monitoring and control requirements with the monitoring manager.
Revises and resubmits rejected service monitoring and control requirements.

SMC Service Manager

The SMC service manager is the process owner with end-to-end responsibility for the service monitoring and control process. The SMC service manager has the following responsibilities:
Identifies, collects, and manages requirements from SMC and other SMC requirements initiators.
Works with release management to deploy the service monitoring and control technical solution.
Reviews the service monitoring and control process.
Reports on and maintains the service monitoring and control process.
Provides regular feedback on operational performance, both in general and against specific service levels.
Manages monitoring operators.

SMC Monitoring Operator

The monitoring operator is responsible for the day-to-day execution of the service monitoring and control process and utilizes, wherever possible, automated incident-detection tools.

When an incident occurs, the monitoring operator role reacts and attempts to solve it, or ensures that the incident is transferred to specialist support teams for investigation, diagnosis, and resolution.

The SMC monitoring operator has the following responsibilities:
Performs the service monitoring and control process.
Configures automated monitoring of system components.
Across multiple shifts, detects management/system events and raises alerts.
Ensures incidents are raised within the incident management process as required.

SMC Engineer/Architect

The engineer/architect role is responsible for providing higher-level support for the relevant day-to-day execution of the service monitoring and control process. The provider utilizes, wherever possible, automation and tools.

The engineer/architect has the following responsibilities:
Performs the service monitoring and control process and is especially focused on the Establish, Assess, and Implement process flow activities.
Produces, reports on, and maintains the service monitoring and control capability.
Designs the service monitoring and control technical solution.
Develops the service monitoring and control technical solution.
Configures automated monitoring of system components.
Ensures detection of alerts from all infrastructure components within the area of responsibility.
Configures the system-specific events to be monitored.
Configures SMC tools according to service level requirements.
Ensures that system resources are in good working order.
Monitors backup, restore, recovery, and verification procedures.

SMC Developer and Tester

These roles are responsible for extending and integrating components of SMC tools and technologies.

The SMC developer has the following responsibilities:
Develops integration and extends the SMC tool.
Extends tool capabilities using API and Frameworks.
Creates scripts and status probes used in the Monitor and Control process flow activities.
Participates in discussions with application and software development teams.

The SMC tester has the following responsibility:
Tests the internally developed capabilities and extensions.

Relationship to Other Processes

Overview

Every process within Microsoft Operations Framework benefits from some aspect of service monitoring and control because these functions are inherent to ongoing process improvement. This is especially true in the Operating Quadrant of the MOF Process Model where SMFs are closely interrelated.

In the Operating Quadrant, system administration is the overarching service management function. It provides the organizational framework for performing the fundamental day-to-day operational functions (bottom-row SMFs in FIG. 11) as filtered through security administration and service monitoring and control.

System administration is also uniquely and critically tied to security administration, which fills the second tier of this hierarchy, by defining the security context in which all of the SMF procedures are carried out.

Security administration is tightly coupled with service monitoring and control and acts as a filter to ensure that corporate security standards are adhered to and security is not compromised. Security administration may also perform some of its own monitoring and auditing services, possibly separately from that provided directly by service monitoring and control.

Service monitoring and control reactively and proactively monitors the infrastructure and the actions across the other operations functions (the four bottom-row SMFs in FIG. 11). Service monitoring and control staff must conform to the security guidelines created by security administration.

Using a financial billing system as an example, there are daily operations functions and underlying tasks that must be performed in order to operate and maintain the application. At a service management function level, they are broken down into:
Job scheduling. Ensures that system data is processed efficiently and in a timely manner and looks after any batch-processing requirement.
Network administration. Ensures network throughput, capacity, and availability to support the Operating Quadrant SMFs that facilitate transaction processing, reporting, user inquiries, and application support functions for the application.
Directory services administration. Allows users and the application to locate network resources such as users, servers, applications, tools, services, and other necessary information over the network.
Storage management. Ensures proper data backup, restore, recovery, and management of storage resources.

Note: Following the release of MOF version 3.0, the Print and Output Management SMF has been incorporated into the Storage Management SMF.

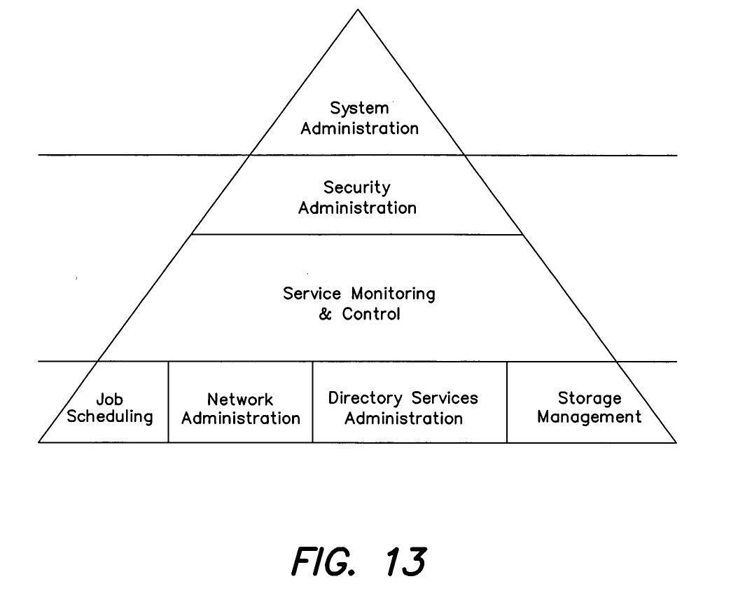

FIG. 13 illustrates the interactions of the SMFs in the Operating Quadrant. System Administration is the overarching service management function and provides the organizational framework for performing the fundamental day-to-day operational functions (bottom row SMFs) as filtered through Security Administration and Service Monitoring and Control.

System Administration, within this context, is uniquely and critically tied to the Security Administration SMF, which fills the second tier of this hierarchy by defining the security context in which all of the SMF procedures are carried out. The Service Monitoring and Control SMF is responsible for providing visibility into the health of systems managed by the SMFs below it.

Incident Management

When the performance of service monitoring requires that a manual action be taken, then the incident management process is required to raise an incident record. This record is then updated during the operation of service monitoring and control, using the agreed-on incident management process.

In a similar way, if the monitoring of a service by service monitoring and control is suspended or stopped, there may be a requirement to raise an incident record

Service monitoring and control should also provide regular incident updates on progress and work carried out so far to solve the incident.

Incident management should work closely with service monitoring and control in order to manage incidents from initial detection through to closure, and to provide tracking, recording, and closure of incidents relating to service monitoring and control.

Service Level Management

Service level management (SLM) should work closely with service monitoring and control in order to initiate monitoring and control requirements, particularly when a new service is being proposed for implementation. This is captured in SLM's work products including the SLAs, OLAs and UCs.

SLM should be closely involved in agreeing on the final service monitoring and control monitoring requirements that will be implemented, taking account of requirements that are impractical or too costly to implement or difficult to duplicate.

Once a new service has been implemented and is in operation, service level management is involved in reviewing the service monitoring and control requirements for that service on a regular basis. This should form part of the general service monitoring and control review process carried out to ensure that the processes are still valid and to identify weaknesses in the people, process, and tools elements of service monitoring and control.

Service level management should ensure that the service monitoring and control processes cover all services in the service catalog.

Historic performance data is invaluable for service level management when discussing and agreeing on service and operating level agreements (SLAs and OLAs) and requirements (SLRs and OLRs). The performance data may be related to informal service levels when no formal SLAs exist.

Service monitoring and control should work closely with service level management in order to provide the service level manager with data that he or she can use to create reports on the infrastructure that supports the services being delivered. Service monitoring and control also monitors the components that make up the service, providing the basis for vital statistics on how monitored services are performing on a day-to-day basis.

Service monitoring and control also provides early visibility of actual and potential service breaches, which may allow remedial action to be taken before a breach occurs.

Capacity Management

Capacity management is the IT process that enables an organization to manage IT resources and predict in advance when additional resources will be needed to provide required services.

Driven by SLAs, the capacity manager needs to supply IT with the OLRs required to support the service capacity commitments being made between IT and the user community.

Staff responsible for ensuring service capacity requires service monitoring and control to provide management data views concerned with service capacity. Service monitoring and control should also produce the relevant capacity data that will be used in the production of a capacity plan.

Capacity management should work closely with service monitoring and control in order to initiate monitoring and control requirements, particularly when a new service is being proposed for deployment. They should be closely involved in agreeing on the final service monitoring and control requirements that are implemented, taking account of requirements that are impractical or too costly to implement or difficult to duplicate.

Once a new service has been implemented and is in operation, the capacity manager should be involved in reviewing the service monitoring and control requirements for that service on a regular basis. This should form part of the general service monitoring and control review process to ensure that the processes are still valid.

Capacity management should also assist with the specification of the infrastructure and tools to support service monitoring and control.

The layers that should be monitored for capacity management are:
Application
Middleware
Operating system
Hardware
LAN
Facilities
Egress

Availability Management

Availability management is the IT process that enables IT organizations to achieve and sustain the IT service availability that customers need to efficiently support their business at a justifiable cost. This process focuses on the procedures and systems required to support availability requirements in SLAs or informal service levels when no SLAs exist. The procedures and systems include specification and monitoring of suppliers' contractual obligations regarding availability.

Driven by SLAs, the availability manager needs to supply IT with the operating level requirements needed to support the service availability commitments being made between IT and the user community.

Staff responsible for ensuring service availability will require service monitoring and control to provide management data views concerned with overall service availability.

Availability management should work closely with service monitoring and control in order to initiate monitoring and control requirements, particularly when a new service is being proposed for implementation. They should be closely involved in agreeing on the final service monitoring and control requirements that are implemented, taking account of requirements that are impractical or too costly to implement or too difficult to duplicate.

Once a new service has been implemented and is in operation, the availability manager should be involved in reviewing the service monitoring and control requirements for that service on a regular basis. This should form part of the general service monitoring and control review process to ensure that the processes are still valid.

Service monitoring and control should produce relevant availability data for use in the production of an availability plan and for identifying the impact on availability caused by incidents and underlying problems. Availability management should then aim to reduce the impact of future incidents by implementing resilience measures.

The layers that should be monitored for availability management are:
Application
Middleware
Operating system
Hardware
LAN
Facilities
Egress

Change Management

Change management is ultimately responsible for ensuring that all approved changes generate the appropriate work orders and are monitored throughout the change management life cycle, working with release management when required.

Service monitoring and control should therefore work closely with change management in order to identify approved changes that may affect monitoring requirements. The change manager should also be heavily involved in the deployment of new service monitoring and control infrastructure, tools, and configuration changes.

Once a change has been implemented, the affected components should be monitored to ensure they are functioning as expected. If the implemented change is adversely affecting either the IT environment or users, the change manager should be notified and appropriate actions should be taken, which may include backing out the change.

Change management should also approve the stopping and starting of service monitoring and control on a particular service or service component. This should be performed in liaison with service level management and the change advisory board where appropriate.

Configuration Management

The tools available to the service monitoring and control process may be used to gather data on the physical state of configuration items (CIs) and validate the integrity of the configuration management database. (For example, do the CIs really exist? Are there CIs in production environments that are not recorded in the CMDB?)

Monitoring and control could prove vital to the configuration management process to help ensure that the configuration management database is accurate. If it is not accurate, the CMDB is of little value to the other processes that make considerable use of it, such as incident management, problem management, release management, and change management.

Monitoring the IT infrastructure in the production environment should not only detect planned changes to configuration items, but also should detect unplanned changes to the environment. These unplanned changes can result in discrepancies between what is reported in the CMDB and what really exists in the IT environment.

Configuration management should also work closely with release management to ensure that new service monitoring and control infrastructure, tools, and configuration changes are captured upon deployment.

Problem Management

Service monitoring and control provides problem management with ongoing performance data and current values across the production environment to assist in the investigation of the root cause of incidents and the identification of known errors. The investigation of problems may lead to the need for additional service monitoring and control requirements for a short period of time to assist in the investigation process. This ability to monitor potential problem areas is invaluable to the successful operation of the problem management function.

Problem management should work closely with service monitoring and control in order to initiate monitoring and control requirements. They should be closely involved in agreeing on the final service monitoring and control requirements that are implemented, taking account of requirements that are impractical or too costly to implement or too difficult to duplicate.

Once a new monitoring requirement service has been implemented and is in operation, the problem manager should be involved in reviewing the service monitoring and control requirements for that service on a regular basis. This should form part of the general service monitoring and control review process to ensure that the processes are still valid.

Release Management

Service monitoring and control should work closely with release management in order to identify approved releases that may affect monitoring requirements.

The release manager should also be heavily involved in the deployment of new service monitoring and control infrastructure, tools, and configuration changes because this role is responsible for ensuring that all approved releases are managed through the release management life cycle, adhering to change management standards throughout.

Prior to introducing a new release into the production environment, the release manager must provide the service monitoring and control process with an appropriate notification that a release is going to occur in order to agree on the service monitoring and control requirements for that service. This enables configuration of the necessary monitoring tools to monitor and control the service components associated with any new release.

Directory Services Administration

Directory services administration is directly involved with monitoring and controlling (administering) the legion of directories in an organization. This can include replication, metadirectory services, and so on.

Directory services administration should work closely with service monitoring and control in order to initiate monitoring and control requirements, particularly when a new service is being proposed for implementation. They should be closely involved in agreeing on the final service monitoring and control requirements that are implemented, taking account of requirements that are impractical or too costly to implement or too difficult to duplicate.

Once a new service has been implemented and is in operation, the directory services administration manager should be involved in reviewing the service monitoring and control requirements for that service on a regular basis because part of the requirements of the general service monitoring and control review process is to ensure that the processes are still valid.

The layers that should be monitored for directory services administration are:
Middleware
Operating system
Hardware
LAN
Facilities
Egress

Network Administration

Network administration is directly involved with day-to-day monitoring and controlling (administering) of all network infrastructure components. This can include hubs, switches, routers, and external network providers.

Network administration should work closely with service monitoring and control in order to initiate monitoring and control requirements, particularly when a new service is being proposed for implementation. They should be closely involved in agreeing on the final service monitoring and control requirements that are implemented, taking account of requirements that are impractical or too costly to implement or too difficult to duplicate.

Once a new service has been implemented and is in operation, the network administrator should be involved in reviewing the service monitoring and control requirements for that service on a regular basis. This should form part of the general service monitoring and control review process to ensure that the processes are still valid.

Service monitoring and control should provide regular feedback on network performance, both in general and against specific agreed-on service levels, and should capture and convey the detection of alerts from the network infrastructure to the network administration team.

Network administration should therefore work closely with service monitoring and control in order to install, configure, and maintain the network components and to provide the required technical support for them following deployment.

The layers that should be monitored for network administration are:
LAN
Facilities
Egress

Security Administration

Security administration is tightly coupled with service monitoring and control. It acts as a filter to ensure that corporate security standards are adhered to and that security is not compromised. Security administration may also perform some of its own monitoring and auditing services, possibly separately from that provided directly by service monitoring and control.

Service monitoring and control staff must conform to the security guidelines created by security administration.

Security is an important part of system infrastructure. An information system with a weak security foundation eventually experiences a security breach, such as the loss of data, the disclosure of data, the loss of system availability, and the corruption of data.

Depending on the information system and the severity of the breach, the results could vary from embarrassment, to loss of revenue or loss of life.

The primary goals of security are to ensure:
Data confidentiality. No one should be able to view data if they are not authorized to do so.
Data integrity. All authorized users should feel confident that the data presented to them is accurate and not improperly modified.
Data availability. Authorized users should be able to access the data they need, when they need it.

The Security Administration SMF may also perform its own monitoring and auditing services, possibly separately from that provided by service monitoring and control. The service monitoring and control staff must also conform to the security guidelines created by the security administration team.

Security administration should work closely with service monitoring and control in order to initiate monitoring and control requirements, particularly when a new service is being proposed for implementation. They should be closely involved in agreeing on the final service monitoring and control requirements that are implemented, taking account of requirements that are impractical or too costly to implement or too difficult to duplicate.

Once a new service has been implemented and is in operation, the security administration manager should be involved in reviewing the service monitoring and control requirements for that service on a regular basis. This should form part of the general service monitoring and control review process to ensure that the processes are still valid.

Job Scheduling

Job scheduling ensures that system data is processed efficiently and in a timely manner and looks after any batch-processing business requirements.

Service monitoring and control provides job scheduling with monitoring and control of scheduled jobs. This may include:
Schedule times
Termination results
Dependencies
Schedules
Schedule clashes and issues
Success or failure of jobs

Job scheduling should also work closely with service monitoring and control in order to initiate monitoring and control requirements, particularly when a new service is being proposed for implementation. They should be closely involved in agreeing on the final service monitoring and control requirements that are implemented, taking account of requirements that are impractical or too costly to implement or too difficult to duplicate.

Once a new service has been implemented and is in operation, the job scheduling manager should be involved in reviewing the service monitoring and control requirements for that service on a regular basis. This should form part of the general service monitoring and control review process to ensure that the processes are still valid.

Service monitoring and control should work closely with job scheduling in order to produce relevant trending and statistical data for use in evaluating the ongoing performance of the Job Scheduling SMF.

The layers that should be monitored for job scheduling are:
Application
Middleware
Operating system
Hardware
LAN
Facilities
Egress

Storage Management

Service monitoring and control provides storage management with monitoring and control of storage devices (such as hard disks and tapes), printers, and other output devices. This may include current data values on high or low storage space, utilization issues, and the status of backup and recovery jobs.

The performance of service monitoring and control may provide warnings about paper jams, out-of-paper scenarios, and other print queue issues such as a printer being offline.

Storage management should also work closely with service monitoring and control in order to initiate monitoring and control requirements, particularly when a new service is being proposed for implementation. They should be closely involved in agreeing on the final service monitoring and control requirements that are implemented, taking account of requirements that are impractical or too costly to implement or too difficult to duplicate.

Once a new service has been implemented and is in operation, the storage manager should be involved in reviewing the service monitoring and control requirements for that service on a regular basis. This should form part of the general service monitoring and control review process to ensure that the processes are still valid.

Service monitoring and control should work closely with storage management in order to produce relevant trending and statistical data for use in ongoing performance of the Storage Management SMF.

System Administration

In the Operating Quadrant, system administration is the overarching service management function. It provides the organizational framework for performing the fundamental day-to-day operational functions as filtered through security administration and service monitoring and control.

System administration executes the administration model used by an organization. Some organizations prefer a model where all IT functions are performed at a single site with a team of IT professionals co-located at that site. Other organizations prefer a distributed branch-office model where both technologies and support staff are geographically distributed. System administration examines the trade-offs of each model.

Each type of system administration model has unique monitoring requirements. Service monitoring and control enables system administrators to detect and act on incidents and system events regardless of their physical proximity to the systems.

Service monitoring and control should work closely with system administration in order to produce relevant trending and statistical data for use in ongoing performance of the System Administration SMF.

System administration should work closely with service monitoring and control in order to initiate monitoring and control requirements, particularly when a new service is being proposed for implementation. They should be closely involved in agreeing on the final service monitoring and control requirements that are implemented, taking account of requirements that are impractical or too costly to implement or too difficult to duplicate.

Once a new service has been implemented and is in operation, the system administration manager should be involved in reviewing the service monitoring and control requirements for that service on a regular basis as part of the general service monitoring and control review process to ensure that the processes are still valid.

Security Management

The goal of the Security Management SMF is to define and communicate the organization's security plans, policies, guidelines, and relevant regulations defined by the associated external industry or government agencies. Security management strives to ensure that effective information security measures are taken at the strategic, tactical, and operational levels. It also has overall management responsibility for ensuring that these measures are followed as well as reporting to management on security activities. Security management has important ties with other processes; some security management activities are carried out by other SMFs, under the supervision of security management.

Infrastructure Engineering

Infrastructure engineering processes focus on ensuring coordination of infrastructure development efforts, translating strategic technology initiatives into functional IT environmental elements, managing the technical plans for IT engineering, hardware, and enterprise architecture projects, and ensuring quality tools and technologies are delivered to the users.

IT personnel responsible for implementing the processes contained in the Infrastructure Engineering SMF typically perform coordination duties across many other SMFs, liaising with the staffs who implement them. The Infrastructure Engineering SMF has close links to such SMFs as Capacity Management, Availability Management, IT Service Continuity Management, and Storage Management, as well as across ITIL functions such as Facilities Management. It provides a means of coordination between separate, but related, SMFs that was previously lacking in MOF.

The Infrastructure Engineering SMF includes the following activities:
Ensuring that the technology and application portfolio aligns with the business strategy and direction.
Directing solution design and creating detailed technical design documents for all infrastructure and service solution projects.
Verifying the quality assurance efforts of infrastructure development projects and developing standard quality metrics, benchmarks, and guidelines.
Identifying and making recommendations for reducing costs and/or increasing efficiency by employing technological solutions.

Infrastructure engineering is, in several ways, an embodiment of MSF management principles within the MOF Optimizing Quadrant. The processes primarily involve project management and coordination, within an IT operations context. They are linked with nearly every other SMF in order to communicate engineering policies and standards and to ensure that they are included and adhered to when implementing projects and production functions. To accomplish this, those in the Infrastructure Role Cluster (of the MOF Team Model) work with management teams in each of the operations areas to apply guidance from the Infrastructure Engineering SMF. The MOF Risk Management Discipline is performed continually during this process to evaluate whether engineering standards and guidelines are helping to mitigate operations risks across the environment.

Resources

ITIL ICT Infrastructure Management v2.0, OMG

MSM Management Architecture Guide—Managing the Windows Server Platform

Key Performance Indicators

The following statistics should be reviewed to understand the performance of SMC as well as to identify opportunities for improvement. Each value is mapped over predefined timeframes (such as daily/weekly/monthly).
Alert to Ticket Ratio. This is a key statistic that indicates the quality of SMC alerts. The goal is to achieve a 1:1 ratio between alerts and tickets. This indicates that each alert is valid and has a well-defined and well-documented problem set associated with it.
Mean Time to Detection (such as Alert Latency). This statistic should dramatically improve with the implementation of effective SMC tools. Alert latency is the measurement of the delay from when a condition occurs to when an alert is raised. Ideally, this value is as low as possible.
Number of Tickets with No Alerts. A high count of tickets with no alerts is an indication that monitoring missed critical events. This statistic can be used as a starting point for improving instrumentation and rules.
Number of Events per Alert. As rules and correlation improve, this count should increase. Often, multiple events are triggered; however, there is typically only one true source of issue. A high events per alert count may also indicate opportunities for reducing the number of exposed events.
Number of Invalid Alerts. Alerts that are generated with incorrect fault determination should be carefully reviewed and corrected. The number of invalid alerts may increase during the initial deployment of new infrastructure components and services; however, it should drastically decrease with better rules and event filtering.
Mean Time to Repair. This statistic is typically used in capacity and availability management; however, SMC should analyze problems that were corrected using SMC's Control. This metric measures the effectiveness of the automated response from this process. This value should decrease as more situations are handled by SMC automation.

The above-described embodiments of the present invention can be implemented in any of numerous ways. For example, the embodiments may be implemented using hardware, software or a combination thereof. When implemented in software, the software code can be executed on any suitable processor or collection of processors, whether provided in a single computer or distributed among multiple computers. It should be appreciated that any component or collection of components that perform the functions described above can be generically considered as one or more controllers that control the above-discussed function. The one or more controller can be implemented in numerous ways, such as with dedicated hardware, or with general purpose hardware (e.g., one or more processor) that is programmed using microcode or software to perform the functions recited above.

It should be appreciated that the various methods outlined herein may be coded as software that is executable on one or more processors that employ any one of a variety of operating systems or platforms. Additionally, such software may be written using any of a number of suitable programming languages and/or conventional programming or scripting tools, and also may be compiled as executable machine language code.

In this respect, it should be appreciated that one embodiment of the invention is directed to a computer readable medium (or multiple computer readable media) (e.g., a computer memory, one or more floppy discs, compact discs, optical discs, magnetic tapes, etc.) encoded with one or more programs that, when executed on one or more computers or other processors, perform methods that implement the various embodiments of the invention discussed above. The computer readable medium or media can be transportable, such that the program or programs stored thereon can be loaded onto one or more different computers or other processors to implement various aspects of the present invention as discussed above.

It should be understood that the term “program” is used herein in a generic sense to refer to any type of computer code or set of instructions that can be employed to program a computer or other processor to implement various aspects of the present invention as discussed above. Additionally, it should be appreciated that according to one aspect of this embodiment, one or more computer programs that when executed perform methods of the present invention need not reside on a single computer or processor, but may be distributed in a modular fashion amongst a number of different computers or processors to implement various aspects of the present invention.

Various aspects of the present invention may be used alone, in combination, or in a variety of arrangements not specifically discussed in the embodiments described in the foregoing and is therefore not limited in its application to the details and arrangement of components set forth in the foregoing description or illustrated in the drawings. In particular, each of the top-level activities may include any of a variety of sub-activities. For example, the top-level activities described herein may include one or any combination of sub-activities described herein or may include other sub-activities that refine the hierarchical structure of instructing and operating an implementation of an SMC facility.

Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Also, the phraseology and terminology used herein is for the purpose of description and should not be regarded as limiting. The use of “including,” “comprising,” or “having,” “containing”, “involving”, and variations thereof herein, is meant to encompass the items listed thereafter and equivalents thereof as well as additional items.

What is claimed is:

1. A method of operating a service monitoring and control (SMC) facility in a computer system comprising a plurality of services to be monitored, the SMC facility performing a plurality of functions, the method comprising computer-implemented acts of:
during operation of the SMC facility, automatically assessing, at least in part, an effectiveness of the SMC facility in monitoring the computer system; and
in response to the act of automatically assessing, automatically changing at least one of the plurality of functions performed by the SMC facility.

2. The method of claim 1, wherein the act of automatically changing at least one of the plurality of functions comprises an act of adding at least one new function to the plurality of functions performed by the SMC facility.

3. The method of claim 1, wherein the act of automatically changing at least one of the plurality of functions comprises an act of deleting at least one function from the plurality of functions performed by the SMC facility.

4. The method of claim 1, wherein the act of automatically changing at least one of the plurality of functions comprises an act of modifying at least one of the plurality of functions performed by the SMC facility.

5. The method of claim 1, wherein the at least one function comprises monitoring at least one value and comparing the at least one value to at least one threshold, and wherein the act of automatically changing at least one of the plurality of functions comprises an act of automatically changing the at least one threshold in response to the act of automatically assessing.

6. The method of claim 1, wherein the SMC facility comprises at least one SMC tool, the SMC tool adapted to monitor at least one parameter provided by at least one of the plurality of services, and wherein the act of automatically changing at least one of the plurality of functions comprises an act of automatically changing at least one parameter monitored by the at least one SMC tool.

7. The method of claim 6, wherein the act of automatically changing at least one parameter monitored by the at least one SMC tool comprises an act of adding at least one parameter to be monitored by the SMC tool.

8. The method of claim 6, wherein the act of automatically changing at least one parameter monitored by the at least one SMC tool comprises an act of removing at least one parameter to be monitored by the SMC tool.

9. The method of claim 1, further comprising an act of, during operation of the SMC facility, automatically responding to an occurrence of at least one event.

10. The method of claim 9, wherein the act of automatically responding comprises an act of automatically generating at least one notification of the occurrence of the at least one event.

11. The method of claim 9, wherein the act of automatically responding comprises an act of generating at least one diagnostic corresponding to the occurrence of the at least one event.

12. A computer readable medium encoded with a program for execution on at least one processor, the program, when executed on the at least one processor, performing a method of operating, at least in part, a service monitoring and control (SMC) facility in a computer system comprising a plurality of services to be monitored, the SMC facility performing a plurality of functions, the method comprising acts of:
during operation of the SMC facility, automatically assessing, at least in part, an effectiveness of the SMC facility in monitoring the computer system; and
in response to the act of automatically assessing, automatically changing at least one of the plurality of functions performed by the SMC facility.

13. The computer readable medium of claim 12, wherein the act of automatically changing at least one of the plurality of functions comprises an act of adding at least one new function to the plurality of functions performed by the SMC facility.

14. The computer readable medium of claim 12, wherein the act of automatically changing at least one of the plurality of functions comprises an act of deleting at least one function from the plurality of functions performed by the SMC facility.

15. The computer readable medium of claim 12, wherein the act of automatically changing at least one of the plurality of functions comprises an act of modifying at least one of the plurality of functions performed by the SMC facility.

16. The computer readable medium of claim 12, wherein the at least one function comprises monitoring at least one value and comparing the at least one value to at least one threshold, and wherein the act of automatically changing at least one of the plurality of functions comprises an act of automatically changing the at least one threshold in response to the act of automatically assessing.

17. The computer readable medium of claim 12, wherein the SMC facility comprises at least one SMC tool, the SMC tool adapted to monitor at least one parameter provided by at least one of the plurality of services, and wherein the act of automatically changing at least one of the plurality of functions comprises an act of automatically changing at least one parameter monitored by the at least one SMC tool.

18. The computer readable medium of claim 17, wherein the act of automatically changing at least one parameter monitored by the at least one SMC tool comprises an act of adding at least one parameter to be monitored by the SMC tool.

19. The computer readable medium of claim 17, wherein the act of automatically changing at least one parameter monitored by the at least one SMC tool comprises an act of removing at least one parameter to be monitored by the SMC tool.

20. The computer readable medium of claim 12, further comprising an act of, during operation of the SMC facility, automatically responding to an occurrence of at least one event.

21. The computer readable medium of claim 20, wherein the act of automatically responding comprises an act of automatically generating at least one notification of the occurrence of the at least one event.

22. The computer readable medium of claim 20, wherein the act of automatically responding comprises an act of generating at least one diagnostic corresponding to the occurrence of the at least one event.

23. An apparatus adapted to operate, at least in part, a service monitoring and control (SMC) facility in a computer system comprising a plurality of services to be monitored, the SMC facility performing a plurality of functions, the apparatus comprising:
at least one input adapted to receive information about the computer system; and
at least one controller adapted to, during operation of the SMC facility, automatically assess, at least in part, an effectiveness of the SMC facility in monitoring the computer system, and in response to automatically assessing, to automatically change at least one of the plurality of functions performed by the SMC facility.

24. The apparatus of claim 23, wherein the at least one controller comprises means for automatically assessing, at least in part, the effectiveness of the SMC facility in monitoring the computer system and means for, in response to automatically assessing, automatically changing the at least one of the plurality of functions performed by the SMC facility.

25. A method of instructing users in a best practices operation of a service monitoring and control (SMC) facility in a computer system comprising a plurality of services to be monitored, the SMC facility performing a plurality of functions, the method comprising an act of:
instructing users to automatically assess, during operation of the SMC facility, the effectiveness of the SMC facility in monitoring the computer system, and to program the SMC facility to automatically change at least one of the plurality of functions performed by the SMC facility in response to assessments made during operation.

26. The method of claim 25, wherein the act of instructing users to program the SMC facility to automatically change at least one of the plurality of functions comprises an act of instructing users to program the SMC facility to automatically add at least one new function to the plurality of functions performed by the SMC facility.

27. The method of claim 25, wherein the act of instructing users to program the SMC facility to automatically change at least one of the plurality of functions comprises an act of instructing users to program the SMC facility to automatically delete at least one function from the plurality of functions performed by the SMC facility.

28. The method of claim 25, wherein the act of instructing users to program the SMC facility to automatically change at least one of the plurality of functions comprises an act of instructing users to program the SMC facility to automatically modify at least one of the plurality of functions performed by the SMC facility.

29. The method of claim 25, wherein the at least one function comprises monitoring at least one value and comparing the at least one value to at least one threshold, and wherein the act of instructing users to program the SMC facility to automatically change at least one of the plurality of functions comprises an act of instructing users to program the SMC facility to automatically change the at least one threshold in response to the act of automatically assessing.

30. The method of claim 25, wherein the SMC facility comprises at least one SMC tool, the SMC tool adapted to monitor at least one parameter provided by at least one of the plurality of services, and wherein the act of instructing users to program the SMC facility to automatically change at least one of the plurality of functions comprises an act of instructing users to program the SMC facility to automatically change at least one parameter monitored by the at least one SMC tool.

31. The method of claim 30, wherein the act of instructing users to program the SMC facility to automatically change at least one parameter monitored by the at least one SMC tool comprises an act of instructing users to program the SMC facility to automatically add at least one parameter to be monitored by the SMC tool.

32. The method of claim 30, wherein the act of instructing users to program the SMC facility to automatically change at least one parameter monitored by the at least one SMC tool comprises an act of instructing users to program the SMC facility to automatically remove at least one parameter to be monitored by the SMC tool.

33. The method of claim 25, further comprising an act of instructing users to program the SMC to automatically respond to an occurrence of at least one event.

34. The method of claim 33, wherein the act of instructing users to program the SMC to automatically respond comprises an act of instructing users to program the SMC to automatically generate at least one notification of the occurrence of the at least one event.

35. The method of claim 33, wherein the act of instructing users to program the SMC to automatically respond comprises an act of instructing users to program the SMC to automatically generate at least one diagnostic corresponding to the occurrence of the at least one event.
